(19) United States
(12) Patent Application Publication
(10) Pub. No.: US 2025/0209924 A1
(43) Pub. Date: Jun. 26, 2025

(54) SMARTPHONE FLIGHT REGIME RECOGNITION SYSTEM

(71) Applicant: Georgia Tech Research Corporation, Atlanta, GA (US)

(72) Inventors: Annmarie Spexet, Sandy Springs, GA (US); Aprameya Satish, Atlanta, GA (US)

(21) Appl. No.: 18/989,767

(22) Filed: Dec. 20, 2024

Related U.S. Application Data
(60) Provisional application No. 63/612,751, filed on Dec. 20, 2023.

(51) Int. Cl. G08G 5/32; G08G 5/72

(52) U.S. Cl. CPC G08G 5/32; G08G 5/727

(57) ABSTRACT

An exemplary system and method provide flight management monitoring for small, non-commercial aircrafts, e.g., for training/monitoring and maintenance tracking, using a smart phone and its associated sensors (or a remote instrumentation device of the same). The exemplary system and method employ low-cost sensors available on the smart phone or a small sensor instrument and analysis system to identify, in non-real time, flight regimes recorded for a given flight that can be later utilized by the flight or maintenance crew in flight training for the pilot or maintenance operations by the pilot or flight mechanic.

### CROSS REFERENCE TO RELATED APPLICATIONS

This application claims priority to and benefit of U.S. Provisional Patent Application Ser. No. 63/612,751 entitled “SMARTPHONE FLIGHT REGIME RECOGNITION SYSTEM” filed Dec. 20, 2023, which is hereby incorporated by reference herein in its entirety as if fully set forth below.

### BACKGROUND

Commercial aircraft are often equipped with instrumentation for monitoring aircraft operation and improve maintenance operations. Software that are built into aircrafts are often subjected to regulations. Avionics software such as Flight Management Systems (FMS) are commercially available on certain aircrafts to control the aircraft's navigation and autopilot functions and typically require high levels of safety and reliability due to strict regulations from aviation authorities like the FAA, e.g., for flight planning, navigation calculations, and automatic flight path management.

There is a benefit to informally have flight management functionality for non-commercial aircraft usage.

In addition, aerial vehicles, for example, airplanes and helicopters, can require maintenance based on the conditions they fly through and the way they are flown. Flying through inclement weather, high-speed flights, hard landings, and accidents are examples of conditions that might cause an aircraft to require maintenance. Additionally, the length of time that the aircraft is used, and the amount of stress the aircraft is under during use can also be factors in eventually requiring maintenance of an aircraft. Measuring and monitoring the flight of an aircraft can benefit the maintenance and safety of aircraft.

There is a benefit to improving predictive maintenance of aircrafts.

### SUMMARY

An exemplary system and method are disclosed that provides flight management monitoring for small, non-commercial aircrafts, e.g., for training/monitoring and maintenance tracking, using a smart phone and its associated sensors (or a remote instrumentation device of the same). The exemplary system and method employ low-cost sensors available on the smart phone or a small sensor instrument and analysis system to identify, in non-real time, flight regimes recorded for a given flight that can be later utilized by the flight or maintenance crew in flight training for the pilot or maintenance operations by the pilot or flight mechanic. Because the instruments utilized ubiquitously available off-the-shelf components and are not relied upon for safety and reliability of the aircraft or training certification, it does not have meet the strict regulations from aviation authorities for their use, making them available for recreational aircraft use and hobby. The cost of recreational aircraft use is nevertheless high; the usage of the exemplary system and method can reduce the cost of operation for recreational aircraft use and hobby, provide information that can assist with training, and additional aircraft usage information that can be beneficial for the aircraft maintenance.

Flight regime information, e.g., frequency/count of landing and take offs, circling, and execution of certain aerial maneuver can provide beneficial information in tracking flight certification and training and well as anticipated maintenance of aircrafts.

In some aspects, implementations of the present disclosure include a method of performing flight monitoring, the method including: receiving, by a processor of a mobile device, external flight data acquired from one or more sensors of the mobile device external to an aircraft flight controller for an aircraft during flight, wherein the external flight data includes at least one of acceleration data, gyroscope data, or IMU data; windowing, by the processor, the external flight data, cluster the at least one of acceleration data, gyroscope data, or inertia measurement unit (IMU) data of the flight data to define a plurality of time windows; extracting, by the processor, a plurality of features from the windowed flight data; determining, by the processor, based on the plurality of features, a set of flight regimes including at least one of level flight, landing, turning, and taking off, for each of the plurality of time windows; and outputting, by the processor, at a graphical user interface of the mobile device or a remote device, the determined set of flight regimes to be used to monitor flight events.

In some aspects, implementations of the present disclosure include a method further including: receiving, by the processor, accelerometer data captured during a flight and at around 100 Hz and excluding engine frequency; determining, by the processor, period of turbulent event from the accelerometer data; outputting, by the processor, the determined period of turbulent event during the flight.

In some aspects, implementations of the present disclosure include a method further including: determining, via an outlier detection operator, based on the plurality of features, presence of a flight anomaly; and outputting, by the processor, the determined presence of a flight anomaly, wherein the outputted determination for flight anomaly is used for predictive maintenance of the aircraft.

In some aspects, implementations of the present disclosure include a method, further including: determining, by the processor, based on the plurality of features, a flight path for the aircraft for the flight; and outputting, by the processor, at the graphical user interface of the mobile device or the remote device, the determined flight path.

In some aspects, implementations of the present disclosure include a method, wherein the plurality of features includes at least one of: minimum value of each axis of the acceleration data; minimum value of each axis of the gyroscope data; maximum value of each axis of the acceleration data; maximum value of each axis of the gyroscope data; mean value of each axis of the acceleration data; mean value of each axis of the gyroscope data; variance value for magnitude of the acceleration data for one axis; variance value for magnitude of the gyroscope data for one axis; and a value for a signal magnitude area determined for one axis of the acceleration data.

In some aspects, implementations of the present disclosure include a method, including: determining presence of a flight anomaly using a thresholded value from a Mahalanobis distances determined for at least one of the plurality of features; outputting, by the processor, the determined presence of a flight anomaly, wherein the outputted determination for flight anomaly is used for predictive maintenance of the aircraft.

In some aspects, implementations of the present disclosure include a method, wherein the aircraft is a fixed-wing aircraft.

In some aspects, implementations of the present disclosure include a method, wherein the aircraft is a helicopter.

In some aspects, implementations of the present disclosure include a non-transitory computer readable medium having instructions stored thereon, wherein execution of the instructions by a processor causes the processor to: receive external flight data acquired from one or more sensors of the mobile device external to an aircraft flight controller for an aircraft during flight, wherein the external flight data includes at least one of acceleration data, gyroscope data, or IMU data; window the external flight data, cluster the at least one of acceleration data, gyroscope data, or inertia measurement unit (IMU) data of the flight data to define a plurality of time windows; extract a plurality of features from the windowed flight data; determining, by the processor, based on the plurality of features, a set of flight regimes including at least one of level flight, landing, turning, and taking off, for each of the plurality of time windows; and output, at a graphical user interface of the mobile device or a remote device, the determined set of flight regimes to be used to monitor flight events.

In some aspects, implementations of the present disclosure include a computer readable medium, wherein execution of the instructions by the processor further causes the processor to: receive accelerometer data captured during a flight and at around 100 Hz and excluding engine frequency; determine period of turbulent event from the accelerometer data; output the determined period of turbulent event during the flight.

In some aspects, implementations of the present disclosure include a computer readable medium, wherein execution of the instructions by the processor further causes the processor to: determine, via an outlier detection operator, based on the plurality of features, presence of a flight anomaly; and output, by the processor, the determined presence of a flight anomaly, wherein the outputted determination for flight anomaly is used for predictive maintenance of the aircraft.

In some aspects, implementations of the present disclosure include a computer readable medium, wherein execution of the instructions by the processor further causes the processor to: determine based on the plurality of features, a flight path for the aircraft for the flight; and output, at the graphical user interface of the mobile device or the remote device, the determined flight path.

In some aspects, implementations of the present disclosure include a computer readable medium, wherein the plurality of features includes at least one of: minimum value of each axis of the acceleration data; minimum value of each axis of the gyroscope data; maximum value of each axis of the acceleration data; maximum value of each axis of the gyroscope data; mean value of each axis of the acceleration data; mean value of each axis of the gyroscope data; variance value for magnitude of the acceleration data for one axis; variance value for magnitude of the gyroscope data for one axis; and a value for a signal magnitude area determined for one axis of the acceleration data.

In some aspects, implementations of the present disclosure include a computer readable medium, wherein execution of the instructions by the processor further causes the processor to: determine presence of a flight anomaly using a thresholded value from a Mahalanobis distances determined for at least one of the plurality of features; outputting, by the processor, the determined presence of a flight anomaly, wherein the outputted determination for flight anomaly is used for predictive maintenance of the aircraft.

In some aspects, implementations of the present disclosure include a method of performing flight monitoring, the method including: receiving, by a processor of a computing device, external flight data acquired from one or more sensors of a remote instrument external to an aircraft flight controller for an aircraft during flight, wherein the external flight data includes at least one of acceleration data, gyroscope data, or IMU data; windowing, by the processor, the external flight data cluster the at least one of acceleration data, gyroscope data, or inertia measurement unit (IMU) data of the flight data to define a plurality of time windows; extracting, by the processor, a plurality of features from the windowed flight data; determining, by the processor, based on the plurality of features, a set of flight regimes including at least one of level flight, landing, turning, and taking off, for each of the plurality of time windows; and outputting, by the processor, at a graphical user interface of the computing device or a remote device, the determined set of flight regimes to be used to monitor flight events.

In some aspects, implementations of the present disclosure include a method further including: receiving, by the processor, accelerometer data captured during a flight and at around 100 Hz and excluding engine frequency; determining, by the processor, period of turbulent event from the accelerometer data; outputting, by the processor, the determined period of turbulent event during the flight.

In some aspects, implementations of the present disclosure include a method further including: determining, via an outlier detection operator, based on the plurality of features, presence of a flight anomaly; and outputting, by the processor, the determined presence of a flight anomaly, wherein the outputted determination for flight anomaly is used for predictive maintenance of the aircraft.

In some aspects, implementations of the present disclosure include a method, further including: determining, by the processor, based on the plurality of features, a flight path for the aircraft for the flight; and outputting, by the processor, at the graphical user interface of the mobile device or the remote device, the determined flight path.

In some aspects, implementations of the present disclosure include a method, wherein the plurality of features includes at least one of: minimum value of each axis of the acceleration data; minimum value of each axis of the gyroscope data; maximum value of each axis of the acceleration data; maximum value of each axis of the gyroscope data; mean value of each axis of the acceleration data; mean value of each axis of the gyroscope data; variance value for magnitude of the acceleration data for one axis; variance value for magnitude of the gyroscope data for one axis; and a value for a signal magnitude area determined for one axis of the acceleration data.

In some aspects, implementations of the present disclosure include a method, including: determining presence of a flight anomaly using a thresholded value from a Mahalanobis distances determined for at least one of the plurality of features; outputting, by the processor, the determined presence of a flight anomaly, wherein the outputted determination for flight anomaly is used for predictive maintenance of the aircraft.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF DRAWINGS

The accompanying drawings, which are incorporated in and constitute a part of this specification, illustrate embodiments and, together with the description, serve to explain the principles of the methods and systems.

FIG. 1A illustrates an example system for data analysis, including sensors of a portable computing device.

FIG. 1B illustrates an example system for data analysis including one or more external sensors operably coupled to a computing device.

FIG. 2 illustrates an example method of data analysis, according to implementations of the present disclosure.

FIGS. 3A and 3B illustrate altitude and acceleration recorded using an iPhone on a commercial flight from Washing DC to Atlanta, GA.

FIG. 4 illustrates a study of acceleration data from a commercial flight, sections highlighted can be filtered out to focus only on the “cruise” flight condition. versus other events.

FIG. 5 illustrates 100 Hz and 10 Hz acceleration data during an event of likely turbulence during cruise.

FIG. 6 illustrates histograms of acceleration data from a commercial flight, separated by flight regime events.

FIG. 7 illustrates principal components (PCs) from 3-axis accelerometer commercial flight data sampled over 10 second windows with markers indicating a feature vector mapped to the PC space.

FIG. 8 illustrates GPS data from a rotorcraft flight in Atlanta, GA.

FIG. 9 illustrates recalled flight events from the pilot.

FIG. 10A illustrates Z-axis accelerometer data from a mobile device and DTS slice micro overlaid, according to a study of an example implementation of the present disclosure.

FIG. 10B illustrates a Bland-Altman plot comparing Z-axis accelerometry data from cellphone and DTS data, according to a study of an example implementation of the present disclosure.

FIG. 11 illustrates 100 Hz and 10 Hz acceleration data, according to a study of an example implementation of the present disclosure.

FIG. 12 illustrates acceleration data from a commercial flight, where the data is windowed to focus on a cruise flight condition, according to a study of an example implementation of the present disclosure.

FIG. 13 illustrates principle components from 3-axis accelerometer commercial flight data sampled over 10-second windows, including feature vectors mapped onto the principle component space, according to a study of an example implementation of the present disclosure.

FIG. 14 illustrates three-axis cellphone accelerometry during normal flight and

anomalous flight, according to a study of an example implementation of the present disclosure.

FIG. 15 illustrates example clustering performed on helicopter flight data, according to a study of an example implementation of the present disclosure.

### DETAILED DESCRIPTION

To facilitate an understanding of the principles and features of various embodiments of the present invention, they are explained hereinafter with reference to their implementation in illustrative embodiments.

The details of one or more embodiments of the invention are set forth in the accompanying drawings and the description below. Other features, objects, and advantages of the invention will be apparent from the description and drawings and from the claims.

Throughout the description and claims of this specification, the word “comprise” and other forms of the word, such as “comprising” and “comprises,” means including but not limited to, and is not intended to exclude, for example, other additives, components, integers, or steps.

To facilitate an understanding of the principles and features of various embodiments of the present invention, they are explained hereinafter with reference to their implementation in illustrative embodiments.

### Example System

Acquisition and processing of aircraft flight data poses significant technical challenges. Aircraft can include large numbers of sophisticated sensors (e.g., commercial jetliners), or no digital sensors at all (e.g., legacy private airplanes). The flight data acquired can be incredibly voluminous, representing continuous sensor outputs over long periods of time. Additionally, flight data can be from many different sources, including sensors and systems located on and off the aircraft. For example, RADAR data and air traffic control data (e.g., logs, voice recordings) can be acquired simultaneously with data collection by an aircraft's own onboard sensors (if any). Therefore there are significant technical challenges with both acquiring flight data and processing that flight data.

Implementations of the present disclosure can overcome these and other technical challenges with the collection and processing of flight data. For example, implementations of the present disclosure include using mobile devices (e.g., smartphones) to collect data using accelerometers, inertial measurement units (IMUs), gyroscopes, etc, to allow for the collection of flight data in aircraft that may not have sufficient onboard sensors. Additionally, implementations of the present disclosure include deploying sensors onto aircraft (or capturing data from existing sensors) to collect flight data. Implementations of the present disclosure further include methods of improving the processing of flight data by clustering and/or windowing the data for efficient detection of anomalies and other flight events. Accordingly, implementations of the present disclosure allow for improvements to the efficient collection and processing of flight data, which can benefit aircraft maintenance, safety, flight training, and other aspects of aircraft operation.

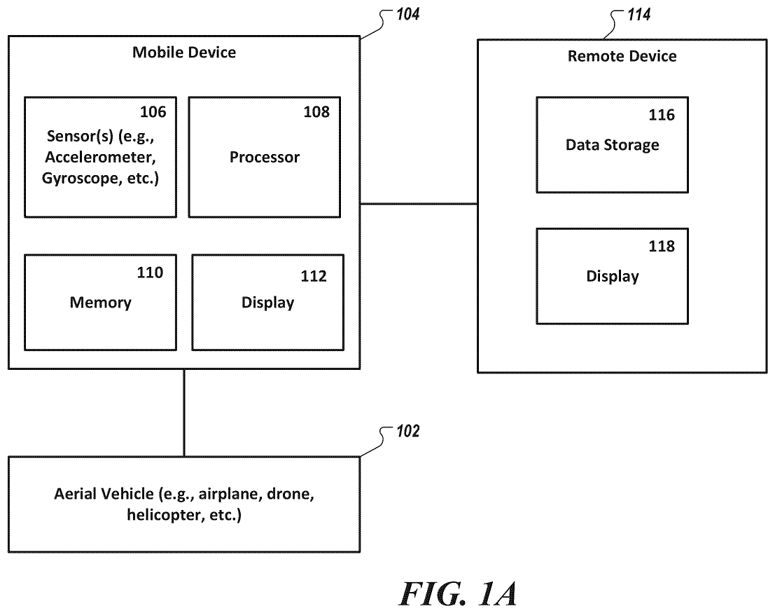

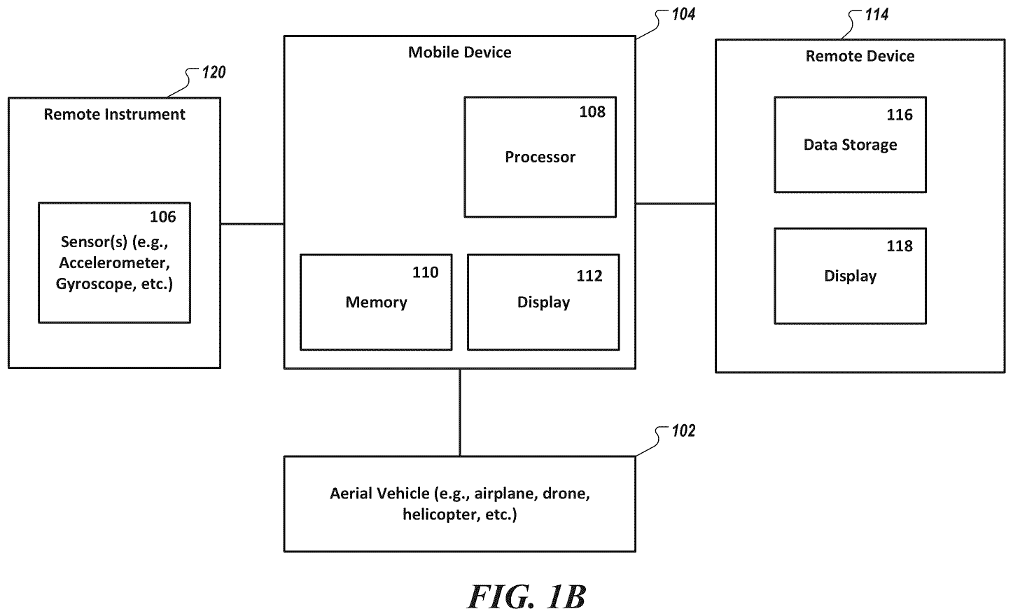

With reference to FIG. 1A, implementations of the present disclosure include systems for collecting and processing flight data of an aerial vehicle 102. Optionally, the aerial vehicle can be any flying vehicle, including airplanes, drones, helicopters, etc. A mobile device 104 (e.g., smartphone, tablet, etc.) can be fixedly mounted to the aerial vehicle 102 so that the motion of the aerial vehicle 102 is imparted to the mobile device 104. The mobile device 104 can optionally include any number of sensors 106, including accelerometers, gyroscopes, compasses, etc. Optionally the sensors 106 can be configured as an inertial measurement unit. The mobile device 104 can further include a processor 108, a memory 110 configured to store data from the sensors 106, and a display 112 configured to display the sensor data.

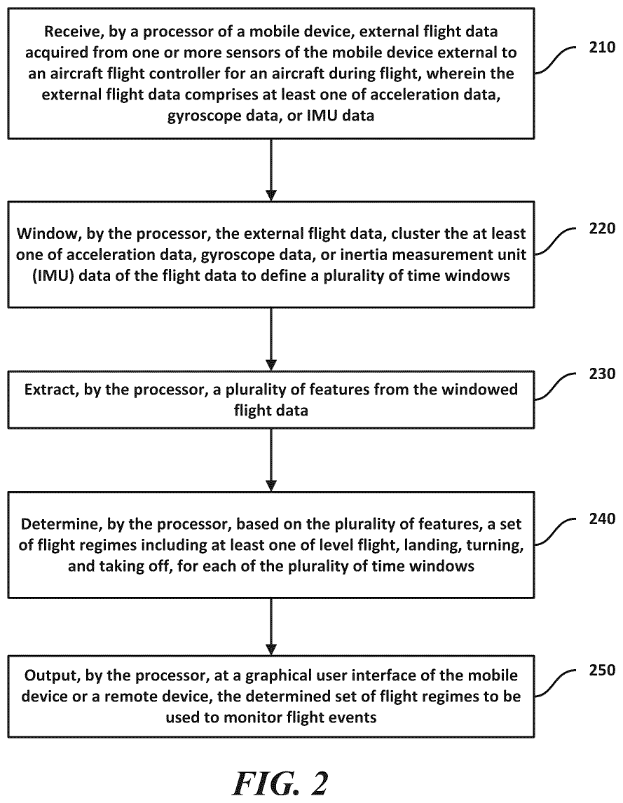

The mobile device 104 can further be configured to process the sensor data stored in the memory 110, for example by executing any of the methods described with reference to FIG. 2.

Still with reference to FIG. 1A, the system can optionally include a remote device 114 that is in communication with the mobile device 104. The remote device 114 can include a data storage (e.g., a memory) and/or a display. The remote device 114 can be in communication with the mobile device 104 through any type of wired and/or wireless network. Optionally, the sensor data stored by the mobile device 104 or processed by the mobile device 104 can be stored in the remote device 116 and/or displayed by the remote device 116. Optionally, the remote device 114 can further include a processor, memory, and other features (not shown). For example, the remote device 114 can be configured as another mobile device, a server, a personal computer, etc. In some implementations, it should be understood that any of the method steps described in FIG. 2 can be performed by a processor of a remote device 114, while the remaining method steps can be performed by the mobile device 104.

With reference to FIG. 1B, in some implementations the sensors 106 can be configured as a remote instrument 120 that is separate from the mobile device 104. For example, the sensors 106 can be located at different locations on the aerial vehicle 102 and configured to transmit (e.g., by a network) data collected to the mobile device 104. It should also be understood that in some implementations, both the remote instrument 120 and mobile device 104 include sensors 106, and that any combination of sensors can be used.

With reference to FIG. 2, an example method of flight monitoring is shown that can be implemented according to implementations of the present disclosure. The methods described with reference to FIG. 2 can be implemented both using a mobile device (e.g., the system illustrated in FIG. 1A) or using a remote instrument with a mobile device (e.g., the system illustrated in FIG. 1B).

At step 210, the method includes receiving, by a processor of a computing device, external flight data acquired from one or more sensors of a remote instrument external to an aircraft flight controller for an aircraft during flight, wherein the external flight data comprises at least one of acceleration data, gyroscope data, or IMU data.

At step 220, the method includes windowing, by the processor, the external flight data cluster the at least one of acceleration data, gyroscope data, or inertia measurement unit (IMU) data of the flight data to define a plurality of time windows.

At step 230, the method includes extracting, by the processor, a plurality of features from the windowed flight data. Non-limiting examples of features that can be extracted from the windowed flight data include: minimum value of each axis of the acceleration data; minimum value of each axis of the gyroscope data; maximum value of each axis of the acceleration data; maximum value of each axis of the gyroscope data; mean value of each axis of the acceleration data; mean value of each axis of the gyroscope data; variance value for magnitude of the acceleration data for one axis; variance value for magnitude of the gyroscope data for one axis; and a value for a signal magnitude area determined for one axis of the acceleration data. It should be understood that implementations of the present disclosure can use any or all of these features in combination with each other, and/or with any other features.

At step 240, the method includes determining, by the processor, based on the plurality of features, a set of flight regimes including at least one of level flight, landing, turning, and taking off, for each of the plurality of time windows; and

At step 250, the method includes outputting, by the processor, at a graphical user interface of the computing device or a remote device, the determined set of flight regimes to be used to monitor flight events.

Implementations of the present disclosure can include methods configured to detect turbulence. For example, the method of FIG. 2 can optionally further include receiving, by the processor, accelerometer data captured during a flight and at around 100 Hz and excluding engine frequency, determining, by the processor, period of turbulent event from the accelerometer data, and outputting, by the processor, the determined period of turbulent event during the flight.

Alternatively or additionally, implementations of the present disclosure can include methods of detecting flight anomalies. For example, the method of FIG. 2 can optionally further include determining, via an outlier detection operator, based on the plurality of features, presence of a flight anomaly; and outputting, by the processor, the determined presence of a flight anomaly, where the outputted determination for flight anomaly is used for predictive maintenance of the aircraft.

Alternatively or additionally, implementations of the present disclosure can include methods of determining and outputting flight paths. For example, the method of FIG. 2 can optionally further include determining, by the processor, based on the plurality of features, a flight path for the aircraft for the flight, and outputting, by the processor, at the graphical user interface of the mobile device or the remote device, the determined flight path.

Alternatively or additionally, implementations of the present disclosure can be used to perform predictive maintenance or determine when to perform predictive maintenance. For example, the method of FIG. 2 can optionally further include determining presence of a flight anomaly using a thresholded value from a Mahalanobis distances determined for at least one of the plurality of features and outputting, by the processor, the determined presence of a flight anomaly, wherein the outputted determination for flight anomaly is used for predictive maintenance of the aircraft.

### Experimental Results and Additional Example

A study was conducted that implemented the present disclosure to perform data summarization related to aircraft maintenance. As described in the present example, data summarization is a process that can reduce and segment data in order to perform subsequent calculations on only relevant segments of data. In aviation, data summarization can include identifying the segments of flight, storage, and maintenance data that contain information relevant to calculating remaining useful life (RUL). Examples of this data include sensor data, flight schedules and maintenance logs. This summarization can be used to reduce data transfer and processing time in subsequent steps. Creating a useful data pipeline that will effectively remove unnecessary segments of data, while leaving in relevant segments, employs a variety of techniques and introduces challenges in deciding when and where summarization is to take place. Once summarized, data are more readily available for downstream processing and inference. In this context, strategic pre-processing for data reduction amounts to data transformation, feature selection and decomposition techniques. Statistical analyses may be used to quantify the efficacy of the data transforms so performed. Data pre-processing for the purpose of summarization becomes even more necessary as fleet size increases, mission tempo increases, and/or the environment becomes more austere. The present example discloses data summarization techniques with examples across several different types of aviation data.

Aviation maintainers can rely on a combination of line checks, time- and usage-based maintenance strategies, and pilot reports to determine the appropriate actions to maximize time-on-wing. Maintenance programs can use data to predict and identify failures, estimate remaining useful life (RUL), intelligently order parts, and select the correct timing for maintenance activities. Increased availability of sensors and computing capacity on aircraft allow for anomaly detection and data collection throughout aircraft operation, instead of only when the aircraft is inspected on the ground.

The increased availability of sensors allows for large amounts of data to be collected in modern aircraft, generating large and/or complicated datasets. Effective management of datasets can be important to deliver data with sufficient quality and speed for processing. Maintenance data can be very large in size, which can prevent calculations from practically being performed on the entire maintenance dataset. Implementations of the present disclosure address these and other limitations by performing calculations on only the relevant segments of data in order to reduce computation time as well as control costs associated with data transmission, storage, and computation. To accomplish these tasks, the example implementation applies several techniques to summarize data in a way that retains pertinent information while reducing the scale of the data. Understanding the applications and motivations of summarization can be particularly useful when applying it to large-scale problems such as aviation maintenance.

Maintenance data can include a wide variety of data, including different types of data at large scales and scopes. Examples include data from components that generate data each millisecond, to handwritten legacy reports, pilot logs, and maintainer logs. Modern, highly-structured data can exist alongside data available from older methods of reporting such as manually entered sensor observations, handwritten maintenance logs, and inspection reports. A comprehensive approach to processing data must take into account availability as well as the quality, quantity, and utility when driving a maintenance action.

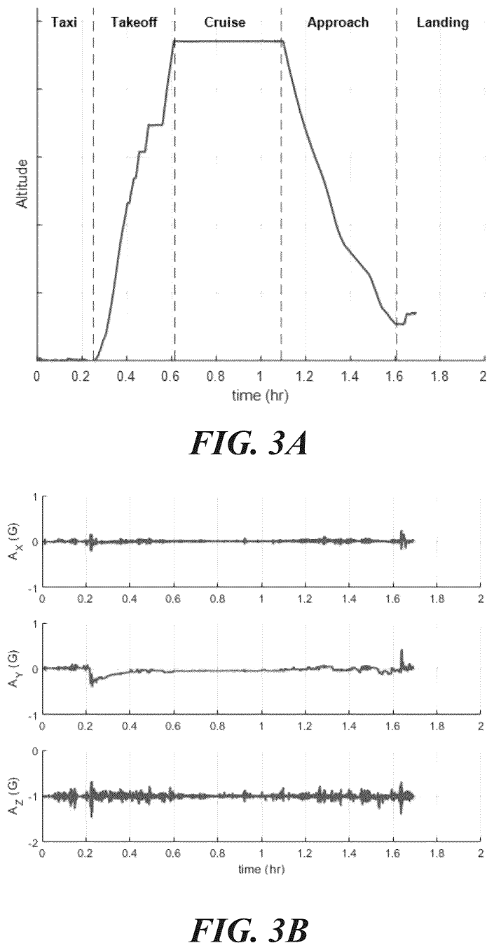

When developing and sustaining an advanced maintenance program, identifying and characterizing the useful and available data streams is one of the first steps in obtaining meaningful insights, as described in FIG. 3A and FIG. 3B. The following sections describe the curation, reduction, and summarization steps necessary to begin developing models and extracting insights from the data.

Data Summarization. The study included applying the techniques described herein section to example data. Data for this study was collected on board multiple types of aircraft, such as commercial flights as well as light fixed wing and rotorcraft. The data collection device, an Apple iPhone, was rigidly mounted inside the cabin where the device's Inertial Measurement Unit (IMU) data captured data at 100 Hz. Although this frequency can be too low to capture high frequency vibrations, such as those that come from the engine, it is able to capture lower frequencies associated with turbulence [40A] as well as larger movements associated with the movement of the aircraft. It should be understood that implementations of the present disclosure can include sampling data at different frequencies, and that 100 Hz is a non-limiting example.

The example implementation includes several different ways to characterize data. The example ways of characterizing data can be categorized into numerical (descriptive statistics such as mean, range, standard deviation), visual (charts, graphs, etc.), or a combination of numerical and visual. The choice of technique to apply depends on the type of data and what is trying to be understood from that data.

In the present example, a consistent data set is used to demonstrate the different summarization techniques. To this end, the data shown in FIG. 3A and FIG. 3B contains the altitude and acceleration information of a commercial flight from Washington DC to Atlanta Georgia recorded using an iPhone. Changes in the altitude plot were used to separate the flight into five temporal regions, (1) Taxi, (2) Takeoff, (3) Cruise, (4) Approach, and (5) Landing.

TABLE 1
Common types of Aviation Data Feeds, adapted from

| Stream | Type of Data |
|---|---|
| On board Sensors | Automated warnings and alerts, flight tracking, |
| | navigation |
| Configuration | Serial Number, Hours used, Number of Cycles |
| Asset/Inventory | Number in Stock, Location, Usage, Purchase logs |
| Operational Data | Pilot assignment, Technician servicing tire |
| Schedule | Airport locations and dates |
| Maintenance | Maintenance shop data, Installation dates, Maintenance |
| History | records, Purchase logs |
| Reporting | Pilot Reports, Installation dates, Maintenance records, |
| | Purchase logs |

There is a distinction to be made between summarizing data and compressing data that is worth discussing due to how
compression is used in aviation data. Compression is the encoding or structural modification of data in such a way that it uses fewer bits. In compression, the expectation is that the data will be able to be fully reconstructed upon receipt with minimal loss. In contrast, the summarization of data may result in some loss of information, but the goal is to only remove data unimportant to subsequent analysis. One example of a specialized dataset where compression is used is in Aircraft Communications Addressing and Reporting System (ACARS) messages, where several options for compression have been identified [2] [3] [4].

Additionally, the self-describing and flexible nature of Extensible Markup Language (XML) can be beneficial as a standard for aviation data due to the disparate formats inherent in aviation, but it can also increase the size of the data [5]. Considerations of compression/decompression time, compression ratio, and the data characteristics (ex: level of redundancy) are typically used to determine which compression algorithm to use [6].

Event Filtering. When working with event-based data, pre-processing can include standard techniques to reduce the dimensionality of the data, such as event collapsing or removing extremely rare events [7]. This pre-processing is completely separate from the challenge of identifying phases within flight data; instead it results in the reduction of the scale of the data while retaining the pertinent information that will ultimately allow for phase and anomaly detection later. While some traditional preprocessing methods for spatial and temporal filtering can garner high compression rates, these methods often come with information loss by missing key patterns in the data [8].

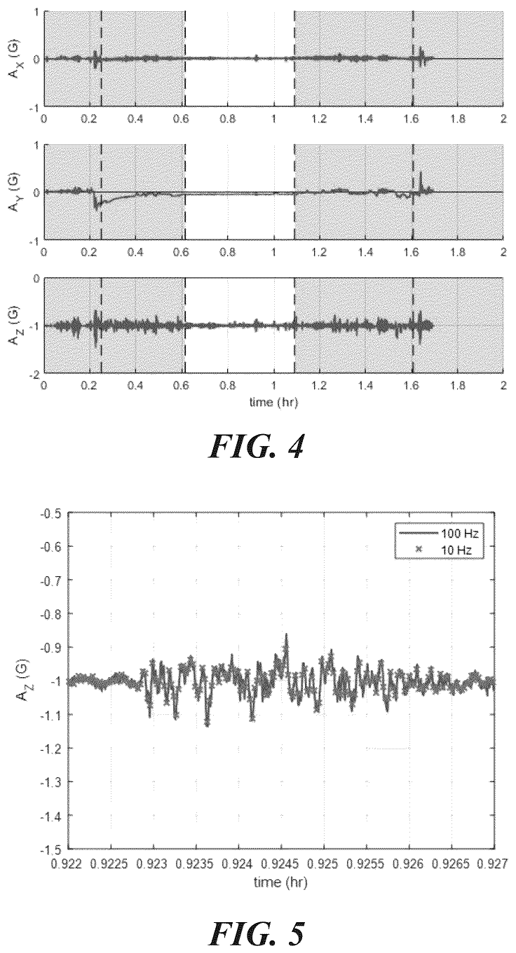

Using the commercial flight data shown earlier in FIG. 3A and FIG. 3B, event filtering can be demonstrated by focusing on just one of the flight regimes. For example, as seen in FIG. 4, if one were to remove all the data in red, everything that is not considered “cruise,” one could reduce the amount of data that needs to be saved and processed by 72 percent. The amount of reduction using this method will vary greatly depending on how events are defined in each application and how numerous they are in the data.

Event Collapsing. Event collapsing is the act of identifying bursts of data related to an event in the same time-window and collapsing the data to a more compact representation in order to capture all the relevant information while reducing dimensionality [9] [10]. Clusters of data representing the same event occur due to a variety of sources, such as the length of logging interval and one failure propagating multiple other failures in the same window [11].

Some research has proposed chunking sensor logs and assigning scores to determine whether or not to retain or discard events [12]. By including a scoring mechanism, they are able to discern more important events within the chunks

TABLE 2
Data Summarization Techniques

| Type | Description | Examples in Literature |
|---|---|---|
| Compression | Coding or restructuring data so it | Bolling[4A], Foster [5A], Roy |
| | takes less space. Output may be | [6A] |
| | lossy or lossless | |
| Event Filtering | Suppressing entries from analysis | Korvesis et al.[7], Zheng et |
| | due to characteristics that | al.[8] |
| | indicate that the entry does not | |
| | contain information of interest | |
| Event | Identifying bursts of data related to | Salfner and Tschirpke[9], |
| Collapsing | the same event and reducing | Buckley |
| | to a compact form | and Siewiorek[10], Liang et |
| | | al.[11], |
| | | Cinque et al.[12], [13] |
| Sampling | Selecting data points at a lower | Bisdikian[14], Kim and |
| | frequency from a continuous | Wang[15], |
| | time signal to represent the whole | Leevy et al.[16], Ahmed[17], |
| | | Jain and |
| | | Chang[18], Giouroukis et |
| | | al.[19], De |
| | | Aquino et al.[20] |
| Aggregation | Using statistical analysis to make | Karvetski et al.[21], Maraiya et |
| | overall statements about a group of | al.[22], Braga and Andrade[23] |
| | data | |
| Discretization | Using statistical analysis to | Ferreira and Figueiredo[24], |
| | separate data into clusters based on | Ghodratnama et al.[25], Li et |
| | their attributes | al. [26], Kleindessner et al. [27], |
| | | Aremu et al.[28], Liu and El- |
| | | Gohary[29] |
| Dimensionality | Finding the relevant subset or | Li et al.[26] |
| Reduction | subset of parameters to represent | |
| | the data you wish to analyze, or | |
| | projecting the higher dimensional | |
| | space into a lower dimension | |
| Natural | Generating textual summaries of | Liu et al.[30A], Sowdaboina et |
| Language | data. | al, [31A], Jiang et al. [32A] |
| Generation | | |

A challenge that often arises during filtering is that noise is often present in sensor logs. This noise can be due to a variety of issues, such as sensor transmission failure or miscellaneous logging that occurs for unrelated reasons. Salfner [9] proposes a filtering methodology that incorporates prior probabilities in order to select for the most relevant events in a training sequence, highlighting these events in contrast to noise. In more recent research, unsupervised approaches have been utilized to filter logs. One of these approaches proposed involves locating event tuples, or multiple events close in time, and then using unsupervised clustering to locate similar tuples [13]. Tuple frequency in a cluster is used to build filtering rules, locating interesting events amongst noise, but relies on domain expert scoring to validate the clusters.

Looking back at the accelerometer data shown in FIG. 3B, event collapsing can be used to summarize the acceleration that occurs during each flight regime event. This is demonstrated in Table 3, as the accelerations in each flight event can be collapsed down into a single value, in this case a mean value, drastically reducing the amount of data required to process. This example is also a form of aggregation, which will be discussed later, as the data is being summarized by one of its statistical properties.

TABLE 3
Mean accelerations for each flight regime event,
an example of the event collapsing technique.

| | Taxi | | Takeoff | | Cruise | | Approach | | Landing | |
|---|---|---|---|---|---|---|---|---|---|---|
| Aₓ | −0.002 | G | −0.002 | G | 0.005 | G | 0.009 | G | 0.010 | G |
| A_{y} | −0.020 | G | −0.089 | G | −0.045 | G | −0.011 | G | 0.013 | G |
| A_{z} | −1.007 | G | −1.003 | G | −1.005 | G | −1.011 | G | −1.008 | G |

Compression. There is a distinction to be made between summarizing data and compressing data that is worth discussing due to how compression is used in aviation data. Compression is the encoding or structural modification of data in such a way that it uses fewer bits. In compression, the expectation is that the data will be able to be fully reconstructed upon receipt with minimal loss. In contrast, the summarization of data may result in some loss of information, but the goal is to only remove data unimportant to subsequent analysis. One example of a specialized dataset where compression is used is in Aircraft Communications Addressing and Reporting System (ACARS) messages, where several options for compression have been identified [4A] [5A] [6A].

The self-describing and flexible nature of Extensible Markup Language (XML) makes it tempting to use as a standard for aviation data due to the disparate formats inherent in aviation, but it also increases the size of the data [33A]. Considerations of compression/decompression time, compression ratio, and the data characteristics (ex: level of redundancy) are typically used to determine which compression algorithm to use [34A].

Natural Language Processing. There has been some exploration in utilizing linguistic techniques to describe sensor data [36A], resulting in summaries of the data that can take the form of responses. For example, when a set of data contains many temperature values that are very hot, the techniques would display a phrase such as ‘most of temperatures are high.’ The primary challenge for this application of machine learning is that there needs to be agreement on what is meant by the terminology chosen.

Large Language Models (LLMs) have shown promise in automated data summarization, and the emergent technology is being evaluated in data landscapes such as medical evidence [37A]. These models require extensive training with a sizable amount of representative data. This may not always be possible to acquire for all applications, especially when considering edge cases in flight regimes and equipment anomalies. Recent work on Retrieval Augmented Generation (RAG) [38A] allows for aviation data practitioners to extend the capability of trained LLMs with domain specific knowledge without needing to retrain the model, such that the LLM remains useful to the specific application.

Another avenue of research explores techniques such as rough sets to extract, which extract the relevant data by means of a genetic algorithm to discretize [39A]. However, a challenge of this method is that it generally needs to be run with a specific target in mind and may not be generalized for all anticipated downstream plans.

Sampling. Statistical techniques for summarizing data rely on the underlying distributions of the data in order to discern the most interesting features and data points [14]. Sampling is one of the most common methods of summarization due to its simplicity, but it often falls short in guaranteeing representation of all the most pertinent events and values in the data. In the context of predictive maintenance, it is a useful method for adjusting data for class imbalance, since anomalies or events of interest tend to be much less common than standard activity in the sensor data. Sampling runs a risk of selection bias, as the chosen sample may not be representative of the underlying population. A possible approach to mitigate this risk is to incorporate a means of inverse sampling or other weighting approaches to ensure that the sample is more representative of the population [15].

While it is oftentimes impractical to retain all sensor data in aviation maintenance, it is still common for more data to be stored than is functionally needed for each individual application. Therefore, another step of sampling may occur at the point of model input by utilizing techniques such as Synthetic Minority Oversampling TEchnique (SMOTE) or Random Over Sampling (ROS), to adjust for class imbalances still existing in the data [16]. In the context of this review, the techniques of interest are those pertaining to sampling from the sensor for storage for downstream applications.

When choosing to reduce the size of data via sampling, decisions can be made with based on the sample size is needed in order to ensure information integrity. Recent research has explored adding the Chernoff bound to dynamically calculate the sample size needed for sampling to increase accuracy and decrease computation time [17]. Adaptive sampling is also an option that has been utilized with Kalman filters in order to adjust sampling rates based on the incoming stream volumes [18]. This is distinct from adaptive filtering, which selects the values to keep [19]. Oftentimes a combination of both techniques is needed in order to retain a reasonable amount of data that is sufficient to distinguish periods of interest from normal activity in the operations being explored. An alternative to straight sampling are sketch-based algorithms that reconstruct the stream based on histogram frequencies of the data [20].

FIG. 5 illustrates the impact of reducing the sampling rate from 100 Hz down to 10 Hz on a instance of likely turbulence in the cruise accelerometer data shown earlier in FIG. 3B. For instances of little change in acceleration there is also little impact on down sampling the data. As the signal becomes chaotic, one can start to see some distinct differences in what the higher and lower sampling rates show. Depending on the degree of analysis that needs to be performed, the lower sampling rate may still be sufficient, but care should be taken to not down sample too much as to lose interesting features in the data.

Aggregation. Aggregation is an alternative to sampling that applies clustering algorithms based on some statistical characteristics of the data, such as mean, standard deviation, and percentiles.

Different forms of aggregation exist that have variations on weighting schemes in order to provide summary judgment from the data available. A judgement is an expert decision required to form a probabilistic belief among competing hypotheses given imperfect evidence [21]. Aggregation methods can be hierarchical or non-hierarchical depending on the method chosen and the statistical tests used for evaluation. Hierarchical approaches include tree-based methods that aggregate sensor data as levels extend down from a base station, but they may result in subtrees being lost if any sensor fails down the tree nodes [22]. Non-hierarchical methods include clustering that measure distances between nearest neighbors [23], but this may not always result in perfect clusters: where all members of the cluster belong to the same group [22].

Similar to how event collapsing was used to summarize the accelerations of different flight regime events from FIG. 3B into single values in Table 3 using the mean acceleration value of each event, other statistical characteristics can be tabulated and used to describe the data. As seen in Table 4, values such as standard deviation, maximum acceleration value, and minimum acceleration value, can be calculated along side the mean to describe a data set.

### Discretization

Another statistical approach to handling large amounts of continuous data is discretization. Discretization makes it possible to cluster data into groups based on its attributes, such as high/medium/low. Certain downstream models cannot handle continuous data, so it is often beneficial to include discretized columns of continuous features even if the original features are retained. Some common techniques for discretization are: binning either by equal-width or equal number of observations, binning via clusters such as k-means, using relevance and mutual information criteria [24], or using a decision tree to create bins.

Clustering can be challenging in that outliers and rare events may skew the outcomes of the clusters. An improvement on traditional clustering methods has been proposed that adjusts the weighting of clusters in order to be able to preserve more data than previous algorithms [25]. Density-Based Spatial Clustering of Applications with Noise (DBSCAN) is a well-known clustering algorithm that can work well with flight data, as it can automatically determine the number of clusters and handle data with outliers, which are common characteristics in this domain [26]. In more recent research, a k-center clustering technique has been proposed that implements a fairness constraint to optimize the choice of the k-centers [27].

The choice of discretization technique is important for model performance. Research specific to the domain of predictive maintenance has noted difficulty in using discretization with certain methods, such as discrete Fourier transform and discrete wavelet transforms, as they cannot maintain correlation of data points between the original and discretized forms [28]. To get around this shortcoming, Aremu et al [28] proposes the use of Symbolic Aggregate Approximation (SAX) to maintain the original feature lower-bound distance measure per sample. In other words: the SAX method retains the important details of the original data, such that these details can be used to map data points between the original and discretized forms. Research in discretization of sensor data has evaluated the use of four common methods in order to predict deterioration in bridges [29].

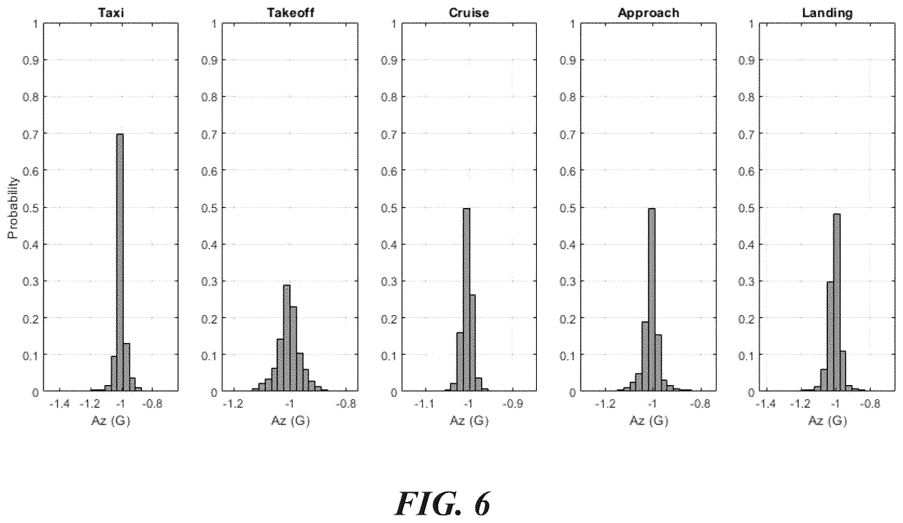

One way of discretizing data is through the use of histograms with bins of equal width, as seen in FIG. 6 for the z-axis of the accelerometer data previously shown in FIG. 3B. Instead of viewing the continuous accelerations during each regime as a function of time, histograms allow one to break each event up and see how likely certain values of acceleration are during such an event. This can be useful when trying to classify and recreate specific events.

TABLE 4
Statistical characteristics of the accelerations measured
in each flight regime event, all values are in G's.

| | Taxi | Takeoff | Cruise | Approach | Landing |
|---|---|---|---|---|---|
| Aₓ | μ = −0.002 | μ = −0.002 | μ = 0.005 | μ = 0.009 | μ = 0.010 |
| | σ = 0.012 | σ = 0.013 | σ = 0.007 | σ = 0.013 | σ = 0.039 |
| | A_{x, max} = 0.164 | A_{x, max} = 0.086 | A_{x, max} = 0.086 | A_{x, max} = 0.121 | A_{x, max} = 0.252 |
| | A_{x, min} = −0.214 | A_{x, min} = −0.076 | A_{x, min} = −0.063 | A_{x, min} = −0.084 | A_{x, min} = −0.180 |
| A_{y} | μ = −0.020 | μ = −0.089 | μ = −0.045 | μ = −0.011 | μ = 0.013 |
| | σ = 0.092 | σ = 0.055 | σ = 0.007 | σ = 0.038 | σ = 0.077 |
| | A_{y, max} = 0.111 | A_{y, max} = 0.001 | A_{y, max} = 0.005 | A_{y, max} = 0.089 | A_{y, max} = 0.424 |
| | A_{y, min} = −0.398 | A_{y, min} = −0.252 | A_{y, min} = −0.079 | A_{y, min} = −0.139 | A_{y, min} = −0.096 |
| A_{z} | μ = −1.007 | μ = −1.003 | μ = −1.005 | μ = −1.011 | μ = −1.008 |
| | σ = 0.035 | σ = 0.041 | σ = 0.014 | σ = 0.038 | σ = 0.040 |
| | A_{z, max} = −0.678 | A_{z, max} = −0.781 | A_{z, max} = −0.861 | A_{z, max} = −0.776 | A_{z, max} = −0.690 |
| | A_{z, min} = −1.469 | A_{z, min} = −1.201 | A_{z, min} = −1.136 | A_{z, min} = −1.279 | A_{z, min} = −1.400 |

Dimensionality Reduction. Dimensionality reduction refers to transforming a high dimensional space into a lower space while retaining the useful properties of the data while discarding redundant features, or those that may contribute to dataset noise.

Principal Component Analysis (PCA) [30] is one of the most common forms of dimensionality reduction for large, multivariate datasets. This method only works for numeric data and has been shown to have some shortcomings with flight data: PCA can lead to biases [26] in the reduced dimensions and can become overly computationally intensive if the number of original features is very large. Due to these shortcomings, Li [26] has proposed weakening the effect of multicollinearity by identifying closely correlated features and then compressing the correlated parameters to summary values. As the PCA output is a compressed representation of the original feature vector, there may be some concern about the fact that the PCA components are not physically interpretable, which can lead to reluctance to adopt this method, especially when being used for unsupervised learning tasks. Regardless, PCA and dimensionality reduction in general is a powerful tool in compressing information while preserving a large portion of the variance of the original data.

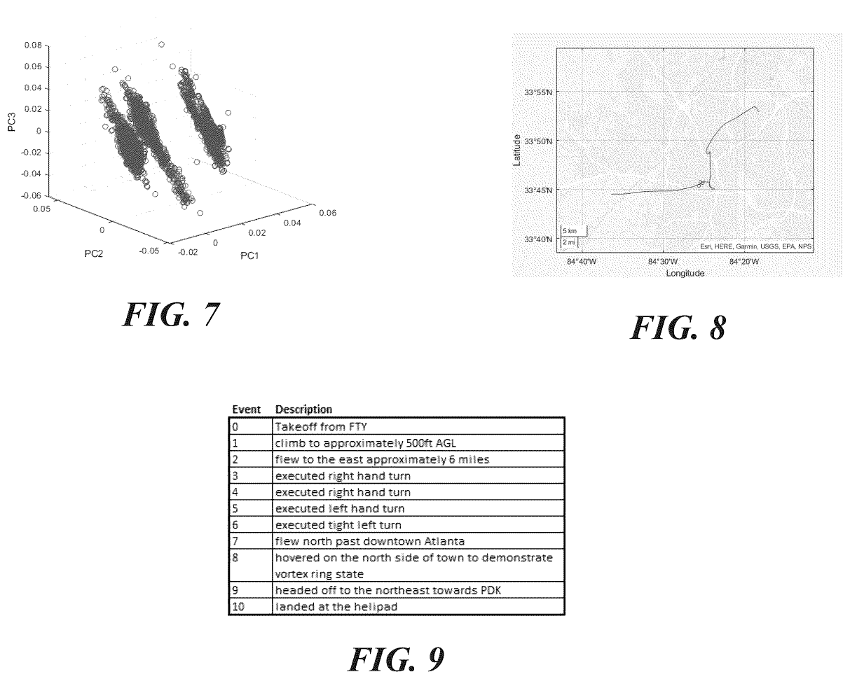

As an example of dimensionality reduction, the accelerometer data from the commercial flight data can be partitioned in 10 second blocks and the aggregated column of (10×100×3)=3000 samples can be treated as a single feature vector that contains information on the dynamics of the aircraft. This fairly large feature vector can then be reduced to 3 dimensions using PCA, and a scatter plot of the resulting PCA manifold is shown in FIG. 7. The figure indicates 3 clusters forming, which can be utilized downstream for further classification tasks. It should be noted that this example is more for illustrative purposes, and has not been tuned to the ideal number of principal components using techniques like scree plots or variance preservation criteria.

Supervised vs. Unsupervised. There are both supervised and unsupervised methods in techniques described in the present example. Supervised learning uses training datasets that have been labelled—where the correct output values have been defined for a subset of the input values. Supervised methods tend to be more accurate than unsupervised, however supervised methods can require labeling, which can require more human effort in the form of labelling data. While unsupervised methods can be less accurate, they are useful for exploratory analysis and situations where labeled data is difficult to obtain. As will also be seen in the example herein, there are also cases where requiring a labeled set can prove challenging to create due to the complex nature of the output.

Other techniques. There has been some exploration in utilizing linguistic techniques to describe sensor data [31], resulting in summaries of the data that can take the form of responses. For example, when a set of data contains many temperature values that are very hot, the techniques would display a phrase such as ‘most of temperatures are high.’

Large Language Models (LLMs) can be used in automated data summarization, and the emergent technology is being evaluated in data landscapes such as medical evidence [32]. These models require extensive training with a sizable amount of representative data. This may not always be possible to acquire for all applications, especially when considering edge cases in flight regimes and equipment anomalies.

Another avenue of research explores techniques such as rough sets to extract, which extract the relevant data by means of a genetic algorithm to discretize [33]. However, a challenge of this method is that it generally needs to be run with a specific target in mind and may not be generalized for all anticipated downstream plans.

Data Summarization Examples. One way to summarize a time series dataset is to identify and extract interesting events, which is sometimes, but not always, the same as anomaly detection. Identifying events that are relevant to make or update a Remaining Useful Life (RUL) estimation requires the combined efforts of subject matter experts at many different levels: pilots, equipment manufacturers, maintainers, and sometimes procurement teams.

Sensored Component Alerts. On larger airframes, certain critical components, such as the powerplant, are heavily sensored. This sensor data is used primarily to provide in-flight fault detection and incident retrospectives. Most modern aircraft flight data monitoring systems incorporate edge computing in some capacity and do not retain all time-series sensor data, but rather, just the requisite event logs as designed by the manufacturer [34]. The operator and often the original equipment manufacturer may never see the full set of raw sensor data from these components. Only the flagged events and possibly excerpts of the raw data in a time window around the event are retained. This is a major and necessary data summarization as engine components are often capable of producing raw sensor data on the order of terabytes per flight hour; however, it makes obtaining full time-series datasets from these components for analysis extremely difficult, if not impossible.

Unsensored Components. Many components on an aircraft are often minimally sensored, if sensored at all. These include structural components, tires, and wiring. These components typically rely on regular visual inspection or preventative maintenance schedules to indicate when they need replacement and to ensure airworthiness. In these cases, summarization across documents such as operating records, maintenance logs, replacement part invoices/inventories, and inspection reports are necessary to perform an RUL analysis. Also beneficial to RUL analysis is information on the aircraft's activities, including data from the navigation system, flight data acquisition unit (FDAU), or through survey technology such as Automatic Dependent Surveillance-Broadcast (ADS-B) devices that are being incorporated into many modern commercial aircraft.

Instrumentation Validation. To demonstrate the validity of using data collected with an IMU on a cellular phone, data for this study was collected on board a Robinson-44 (R44) helicopter, a type frequently used in civilian operations, particularly for flight training. An Apple (Cupertino, CA, USA) iphone 11 Pro was rigidly mounted to the rear seat panel. Accelerometer, gyroscope, altimetry, latitude and longitude, and ground speed data were collected using the SensorLog app [41]. The app sampled data at approximately 33 Hz. Additionally, the DTS Slice Micro accelerometer was used as the “gold standard” 3-axis differential accelerometer, sampled at 2 kHz using a DTS Sliceware (Seal Beach, CA, USA) data acquisition system. This sensor was placed in close proximity to the cellphone to validate the data quality of the accelerometer measurements from the cellphone.

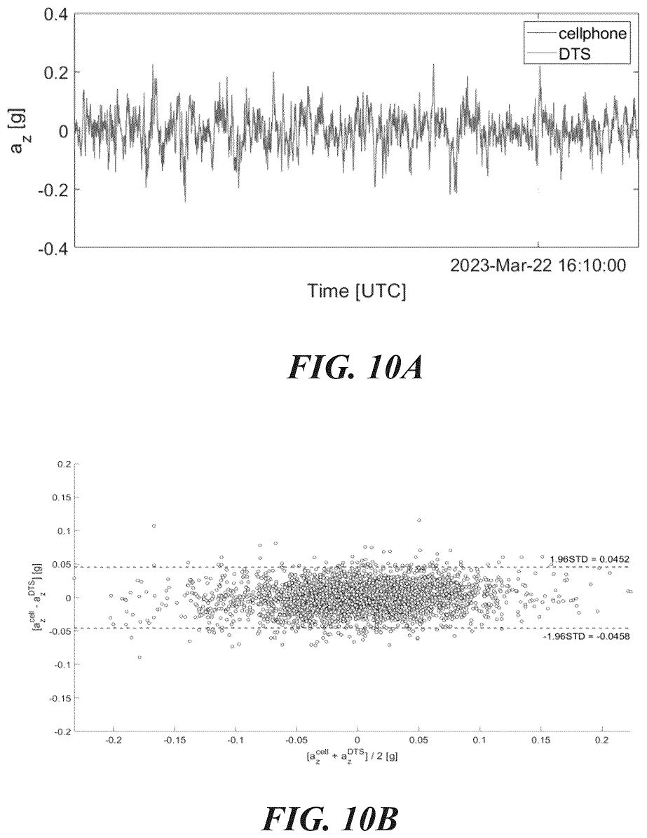

To compare data quality between the cellphone and DTS sensors, data were first downsampled to 10 Hz for both sensors to remove higher order noise from both signals. The downsampling was not expected to cause any data loss since helicopter flight dynamics were expected to be relatively slowly varying. Further, since the cellphone and DTS accelerometer were not truly collocated, the recorded accelerometer signals were expected to have a small shift in time between them. This shift was corrected by manual inspection. FIG. 10A shows the downsampled and aligned accelerometer signals from both sensors, and qualitatively there is resounding agreement between both measurements.

A Bland-Altman plot (FIG. 10B) of accelerometer measurements taken from a portion of nominal helicopter flight (i.e. traveling at constant velocity at constant altitude) shows that accelerometer measurements of the downsampled phone signal compared very well with the high resolution accelerometer data. This validation study provided evidence that the phone accelerometer could faithfully capture flight dynamics with reasonable resolution relative to a gold standard sensor, and that cellphone-based IMU data could be used for downstream flight anomaly detection.

Summarizing Position Data. The data shown in FIG. 8 is the latitude and longitude of a flight path of a helicopter flight in Atlanta, GA. This type of data can be acquired from an onboard sensor, such as the navigation equipment, or through flight tracking service such as FlightAware that uses data from ADS-B signals received from a network of ground receivers. Aircraft with an ADS-B transponder broadcast their identification and their three dimensional position (latitude, longitude, altitude) on 1090 MHz or 978 MHz; this data can be received by a radio within line of sight of the aircraft (a maximum of 300 mi/480 km at cruise). Receivers around the world send this data over a real-time connection to FlightAware, which aggregates the data and provides flight tracking data and interfaces [35].

Depending on the component of interest, different segments of flight data could be relevant. In general, the two ways that flights are described are either with raw data or from a pilot report. Post flight debriefs typically do not give detailed information about what maneuvers that were executed in a flight, as it would rely on the pilots memory of what happened. FIG. 9 gives an example of the types of features a pilot would be likely to describe in a typical post flight briefing. This information can contain information useful for maintenance, but would also need language processing to accommodate technical terms and jargon. It would likely be inconsistent in reporting style and features identified.

For a typical flight, the overwhelming amount of flight data will consist mainly of straight and level flight with very rare to no equipment anomalies or emergency procedures. This rule-of-thumb may vary some depending on the type of fleet under study (flight school vs. commercial airline, rotorcraft vs fixed wing, etc.). This overabundance of one type of flight event causes significant class imbalance against events that are rare but significant to component wear. The challenge of identifying the significant phases of flight is further exacerbated as each individual aircraft type may show different characteristics during the respective flight regimes. While challenging, it is necessary to identify these phases as decision gates, as not all flights are the same length and not all aircraft fly the same profile. This process allows for an equal comparison [36].

A technique used to address these challenges is to apply fuzzy logic on the time series data [37]. Fuzzy logic is a method for analyzing many-valued logic, where the truth value may be any continuous value between 0 and 1 rather than a binary outcome [38]. Instead of only encoding presence or lack with binary values, fuzzy logic allows encoding continuous regimes, such as the speed of an aircraft during different phases of flight and landing. Using fuzzy logic, a model proposed by Sun [37] can handle segments that may not look identical from aircraft to aircraft and still apply accurate phase labels. Other research has proposed possible rule-based models, such as utilizing known codes that are broadcast when an aircraft has or has not taken off and correlating it with the flight data or using the flight plans for a similar purpose [39]. Olive [39] also explored utilizing known trajectories for common patterns, such as holding maneuvers in collaboration with the rule-based and fuzzy logic models in order to account for possible edge cases.

Finally, other researchers have recommended using hybrid machine learning models to classify whether each point in time is a particular phase or not [40] [41]. Hybrid machine learning methodologies are susceptible to the common challenges faced by modeling, such as noisy and missing data. A Generative Adversarial Network (GAN) has been considered for learning the patterns across various aircraft for better discernment of phases, but research into it does not appear to have been completed [40]. Validation of all of the above models is also challenging given that flight data often does not have any ground truth associated with phases, and hand-labeling a substantial amount of data would be prohibitive. Zhang [38] proposes that using synthetic data for validation could assist with these efforts.

Operations and Maintenance Data. In addition to the data sources above, a large part of predictive maintenance is related to text data in the form of pilot reports and maintenance logs. Many of the techniques used to summarize this data rely on classifying the text into categories based on the data, for example: categorizing log entries as ‘routine/schedule’ or ‘nonroutine/repair.’ A number of models exist to tackle this problem, including NaiveBayes classifiers, Artificial Neural Networks, Hidden Markov Models, clustering and decision trees [42].

Implementations of the present disclosure include methods for summarization of textual data includes using a framework for semi-structured and fully-structured summaries that leverages hierarchical clustering and summarization over these clusters; this method defines an optimal sentence to describe each cluster to create a hierarchical concept-map with high informativeness and fluency [43]. This framework allows for the human recipient to be able to direct their search and get the most out of their summaries. This methodology is distinct from those that have been presented for shorter form text [44].

Maintenance Events. Maintenance record data pose different challenges than that of sensor data in that the goal is often to find anomalous maintenance for failures versus regularly scheduled maintenance. Zheng [8] proposes using regular expressions to extract distinct keywords and generate the syntax for categorization of events. From there, classifiers such as Naive Bayes or other categorical models would need to be applied in order to discern the nature of the entry. Some research has proposed correlating log data with other means of ground truth, such as work orders and downtime data, in order to better categorize the entries [45]. Clustering has also been explored as a possible solution [46], with more recent research incorporating additional approaches such as neural networks for improved performance above just clustering models [47]. Clustering techniques can also pose challenges by excluding rare instances of anomalies [17].

UAV Data. Unmanned Aerial Vehicles (UAV) are not often placed in traditional maintenance programs. Due to their relative low cost and a lack of a regulatory requirements, it is often easier to replace the UAV instead of repairing it. However, there are UAV fleets where RUL estimates and replacement/maintenance predictions could be useful, such as in large scale fleets or fleets intended for long term autonomous operation. Commercial options for managing UAV fleets do exist and mainly focus on preventative maintenance management (manufacturer recommendations, recall notices, pilot currency requirements). UAVs can also generate similar sensor datasets as manned aircraft, such as position and component state, and thus could utilize similar maintenance techniques.

One additional factor in UAV operation is the reliance on lithium ion batteries, for which there has been a large amount of work in the area [48] [49] [50]. This type of data is somewhat distinct in the aviation realm, as it incorporates storage and maintenance monitoring considerations that are not commonly seen in other types of components. In general, these components are sensored to monitor voltage, temperature, and other health metrics with a battery management system providing fault codes and alerts that could then be pulled into a larger maintenance program.

Examining Turbulence. The study included an examination of in-flight turbulence. In-flight turbulence is a phenomena may not be considered part of the flight procedure of an aircraft; however, it is a common enough occurrence that it results in hundreds of millions of dollars a year [42A] of costs due to resulting injuries, delays, and added maintenance of aircraft. The presence of turbulence during a flight results in extra strain on the structure of the aircraft that would not have occurred during calm flight conditions. Most modern aircraft use flexible wings, which under moderate to severe air turbulence are subjected to strong tension and bending. [43A] If not accounted for, this extra strain can lead to components wearing out faster than expected and may even result in failure during flight. It is thus important to have a method of tracking when turbulence has occurred during a flight and for how long it was present for: something that may not be adequately documented by pilots or existing flight systems. The most common methods of tracking turbulence includes reports, such as those submitted by the pilot report (PIREPs) or weather and communications data (ACAR/AMDAR). Methods for detecting turbulence using optical, radar, and acoustic techniques [42A] have been considered since the 1970s, while still other methods consider extracting turbulent information from Mode-S and ADS-B signals [44A].

To this end, the data shown in FIG. 3A and FIG. 3B contains the altitude and acceleration information of a commercial flight from Washington DC to Atlanta, Georgia captured with cellular phone IMU as described in the previous section. Changes in the altitude plot were used to separate the flight into five temporal regions, (1) Taxi, (2) Takeoff, (3) Cruise, (4) Approach, and (5) Landing. Event collapsing can be used to summarize the acceleration that occurs during each flight regime event, as is demonstrated in Table 3 as the accelerations in each flight event can be collapsed down into a single value, in this case a mean value, drastically reducing the amount of data required to process. This example is also a form of aggregation, which will be discussed later, as the data is being summarized by one of its statistical properties.

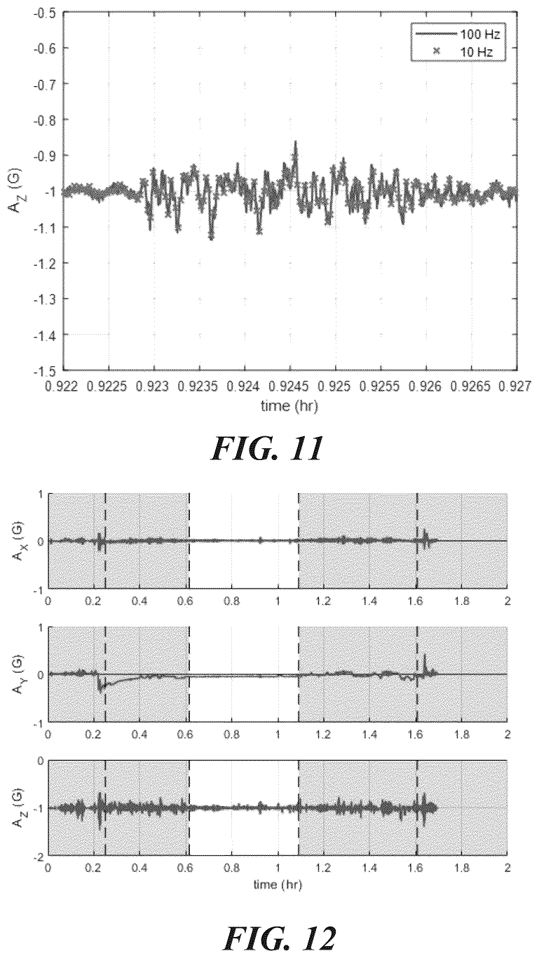

FIG. 11 illustrates the impact of reducing the sampling rate from 100 Hz down to 10 Hz on a instance of likely turbulence in the cruise accelerometer data shown earlier in FIG. 3B. For instances of little change in acceleration there is also little impact on down sampling the data. As the signal becomes chaotic, one can start to see some distinct differences in what the higher and lower sampling rates show. Depending on the degree of analysis that needs to be performed, the lower sampling rate may still be sufficient, but care should be taken to not down sample too much as to lose interesting features in the data.

Using the commercial flight data shown earlier in FIG. 3A, event filtering can be demonstrated by focusing on just one of the flight regimes. For example, as seen in FIG. 12, if one were to remove all the data in red, everything that is not considered “cruise,” one could reduce the amount of data that needs to be saved and processed by 72 percent. The amount of reduction using this method will vary greatly depending on how events are defined in each application and how numerous they are in the data.

Similar to how event collapsing was used to summarize the accelerations of different flight regime events from FIG. 3B into single values in Table 3 using the mean acceleration value of each event, other statistical characteristics can be tabulated and used to describe the data. As seen in Table 4, values such as standard deviation, maximum acceleration value, and minimum acceleration value, can be calculated along side the mean to describe a data set.

One way of discretizing data is through the use of histograms with bins of equal width, as seen in FIG. 6 for the z-axis of the accelerometer data previously shown in FIG. 3B. Instead of viewing the continuous accelerations during each regime as a function of time, histograms allow one to break each event up and see how likely certain values of acceleration are during such an event. This can be useful when trying to classify and recreate specific events.

Anomaly Detection. The data shown in FIG. 8 is the latitude and longitude of a flight path of a helicopter flight in Atlanta, GA, captured with cellular phone IMU as described in the instrumentation section. This type of data can be acquired from an onboard sensor, such as the navigation equipment, or through flight tracking service such as FlightAware that uses data from ADS-B signals received from a network of ground receivers. Aircraft with an ADS-B transponder broadcast their identification and their three dimensional position (latitude, longitude, altitude) on 1090 MHz or 978 MHz; this data can be received by a radio within line of sight of the aircraft provides flight tracking data and interfaces [45A].

Depending on the component of interest, different segments of flight data could be relevant. In general, the two ways that flights are described are either with raw data or from a pilot report. Post flight debriefs typically do not give detailed information about what maneuvers that were executed in a flight, as it would rely on the pilots memory of what happened.

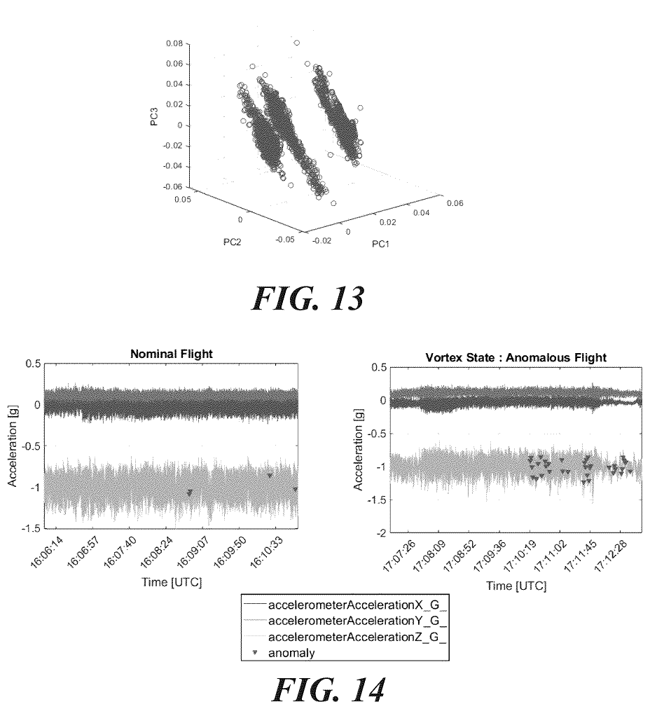

As an example of dimensionality reduction, the accelerometer data from the commercial flight data can be partitioned in 10 second blocks and the aggregated column of (10×100×3)=3000 samples can be treated as a single feature vector that contains information on the dynamics of the aircraft. This fairly large feature vector can then be reduced to 3 dimensions using PCA, and a scatter plot of the resulting PCA manifold is shown in FIG. 13 which indicates 3 clusters forming, which can be utilized downstream for further classification tasks. It should be noted that this example is more for illustrative purposes, and has not been tuned to the ideal number of principal components using techniques like scree plots or variance preservation criteria.

The preliminary anomaly detection pipeline comprised of three stages—the computation of a set of derived features from the collected accelerometer data over fixed duration windows of data, dimensionality reduction of the obtained feature vectors using principle component analysis, and finally a basic tunable outlier detection method. This model was favored over simple thresholding based detections to reduce the high number of false positives that arose in the latter method.

Feature Engineering and dimensionality reduction. In time-series analysis, training models directly on raw accelerometer data can be computationally intensive, susceptible to overfitting, and become difficult from a model explainability standpoint. A common solution to this issue is to generate higher order features derived from the raw data. Typically, these features are computed over pre-defined windows of a set duration. For the cellphone IMU dataset collected, 5 second windows with 50% overlap were used in feature generation. The window size and overlap were determined through trial and error, being mindful that too small a window size would not capture global signal variation, and too large a window would not localize events well. A total of 21 features were computed for each window, informed by [46A]:
(min, max) of acceleration and gyroscope data (12 features)
mean of acceleration and gyroscope data (6 features)
variance and RMS of acceleration magnitude (2 features)
signal magnitude area (SMA) of acceleration (1 feature)

Using a dimensionality reduction technique such as Principal Component Analysis (PCA) [47A] is beneficial to speed up training, and noise removal. In this work, the standardized 21 dimensional feature vector at each window was projected down to 5 dimensions. While it is true that other regularization methods may be better suited to prevent model overfitting, using PCA on the current dataset reduced false positive declaration based on visual inspection of the final results.

Classification. The anomaly detector used in the study declared a detection on data windows based on percentile thresholding of the distance of a feature window from the centroid of all feature windows i.e. the Mahalanobis distance [48A]. It was found that setting the threshold to either the 80th, or 85th percentile of Mahalanobis distances provided reasonable anomaly detection as determined through qualitative inspection of the results, but it should be understood that these thresholds are only intended as non-limiting examples.

Overall, the current anomaly detection framework described in this work was capable of raising flags on large portions of anomalous flying behaviors such as during instances of settling of power. Importantly, the detector raised relatively fewer detections on nominal flight e.g. during level flight, gentle turns etc. indicating high model specificity. FIG. 14 illustrates that the detections declared by the anomaly detector implemented in this study, where a few false positives were raised during the nominal flight, but several during the vortex ring state. While the detections are plotted on the z-axis accelerometer data, it is to be noted that the detections were declared using a model trained with the features described in this study of an example implementation of the present disclosure.

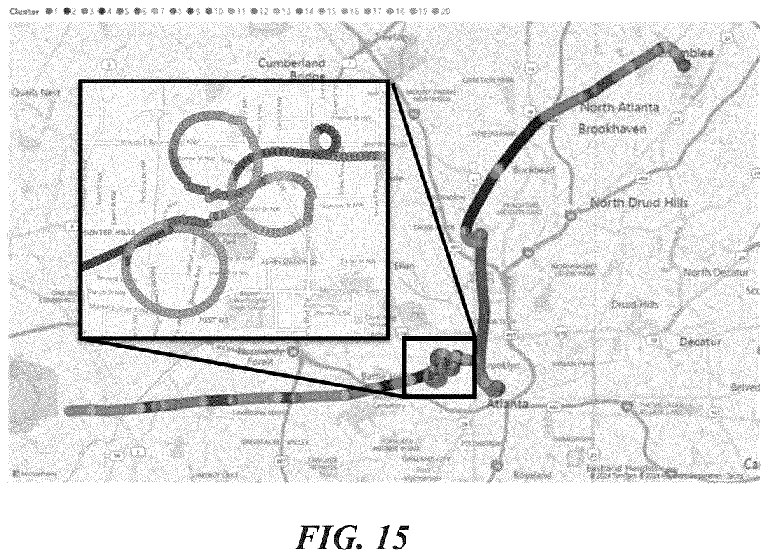

Flight Regime Recognition. There is a wide range in usage on an aircraft that can result in differences in wear on components based on who is using the aircraft and the operating conditions it is being subjected to. Characterizing the type of usage that occurs is not a straightforward classification of normal vs abnormal, but rather an overall portrait of use that might only show patterns against component wear over many flight hours. Identifying the flight regime of an aircraft is a very challenging problem for which many different methods of analysis have been proposed, such as Hidden Markov Models (HMMs) [49A] and neural networks [50A]. Although supervised training methods can be highly accurate for estimating flight regime, they can face challenges when the conditions of flight are highly complex and do not strictly fall into a specific categorization that did not appear in the labeled training flights. To this end, there have been some recent attempts at using unsupervised learning methods such as clustering to identify flight regimes. [51A]. The data shown in FIG. 15 shows the results of clustering on the flight described in FIG. 8. The data was clustered using K-means clustering on the following parameters: Altitude (m); accelerometer X, Y, Z(G); gyrorotation X, Y, Z (rad/s); magnetometer X, Y, Z (μT); Pitch (rad); Roll (rad); Yaw (rad).

Clustering in this way shows accurate groupings in the time series data. Although this data only represents IMU data from a single sensor within the cabin and does not provide any information on vehicle or component health, this segmentation combined with other limited pieces of information can be used to summarize using position, duration, change in maneuver, and other characteristics of flight. This can be used to provide pilots, maintainers, and operators a richer view of the operating conditions that the aircraft is subjected to.

Regardless of the method used to characterize flight regimes, one challenge inherent in the data is that the overwhelming amount of flight data will consist mainly of straight and level flight with very rare to no equipment anomalies or emergency procedures. This rule-of-thumb may vary some depending on the type of fleet under study (flight school vs. commercial airline, rotorcraft vs fixed wing, etc). This overabundance of one type of flight event can cause significant class imbalance against events that are rare but significant to component wear. The challenge of identifying the significant phases of flight is further exacerbated as each individual aircraft type may show different characteristics during the respective flight regimes. While challenging, it is necessary to identify these phases as decision gates, as not all flights are the same length and not all aircraft fly the same profile. This process allows for an equal comparison [52A].

A technique used to address these challenges is to apply fuzzy logic on the time series data [53A]. Fuzzy logic is a method for analyzing many-valued logic, where the truth value may be any continuous value between 0 and 1 rather than a binary outcome [54A]. Instead of only encoding presence or lack with binary values, fuzzy logic allows encoding continuous regimes, such as the speed of an aircraft during different phases of flight and landing. Using fuzzy logic, a model proposed by Sun [53A] can handle segments that may not look identical from aircraft to aircraft and still apply accurate phase labels. Other research has proposed possible rule-based models, such as utilizing known codes that are broadcast when an aircraft has or has not taken off and correlating it with the flight data or using the flight plans for a similar purpose [55A]. Olive [55A] also explored utilizing known trajectories for common patterns, such as holding maneuvers in collaboration with the rule-based and fuzzy logic models to account for possible edge cases.

Hybrid machine learning models can be used to classify whether each point in time is a particular phase or not [56A] [57A]. Hybrid machine learning methodologies can be susceptible to the common challenges faced by modeling, such as noisy and missing data. A Generative Adversarial Network (GAN) has been considered for learning the patterns across various aircraft for better discernment of phases, but research into it does not appear to have been completed [56A]. Validation of all of the above models is also challenging given that flight data often does not have any ground truth associated with phases, and hand-labeling a substantial amount of data would be prohibitive. Zhang [54A] proposes that using synthetic data for validation could assist with these efforts.

### Discussion

Implementations of the present disclosure can be used to overcome problems associated with distilling and summarizing large and frequently disconnected data sets. These operations can be beneficial (or necessary) because they can unnecessary computation, transmission, and storage of data. In aviation predictive maintenance, timing can be particularly critical because some predictions require completion and output analysis in the time it takes to prepare an aircraft for the next flight. Effective management of the dataset for this use will include summarization techniques that reduce the size or dimensionality of the data while still retaining important information.

Selecting the appropriate summarization techniques depends on understanding the nature of the data and the requirements of downstream analysis. Data science teams need to be aware of and understand the differences between techniques and methodologies used to identify, filter, and summarize and how they were used to preprocess the raw data from a complex system. It requires the combined effort of maintainers, subject matter experts, and data scientists and engineers to identify and implement the appropriate strategies in order to maximize the utility of the available data.

The example implementation of the study discloses several systems and methods to summarize aviation data streams to present information useful to flight planners as well as maintenance and operations teams. Inertial Measurement Unit (IMU) data gathered from fixed wing and helicopter flights was summarized in multiple ways, showing that summarization could be used to identify periods or incidents during flight of excessive vibration and unstable movement. In this way, the time period, duration, and level of severity during a flight could be quantified and summarized quickly postflight, and subsequently compared to flights in the same aircraft, flight path, or fleet. The study further demonstrated that through using unsupervised K-means clustering on the IMU data, a partitioning of time series flight data could be obtained that could be used to create a summarized flight description. In addition to serving the useful purpose of reducing the volume of data that must be transmitted, stored, and calculated, both the function of summarization and the techniques used to summarize are fundamental tools necessary to develop higher order analyses and visualizations.

It is to be understood that the methods and systems are not limited to specific synthetic methods, specific components, or particular compositions. It is also to be understood that the terminology used herein is for the purpose of describing particular implementations only and is not intended to be limiting.

Various computing systems may be employed to implement the exemplary system and method described herein. The computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that is not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or maybe hired on an as-needed basis from a third-party provider. Some cloud computing environments may comprise cloud computing resources owned and operated by the enterprise as well as cloud computing resources hired and/or leased from a third-party provider.

In its most basic configuration, a computing device typically includes at least one processing unit and system memory. Depending on the exact configuration and type of computing device, system memory may be volatile (such as random-access memory (RAM)), non-volatile (such as read-only memory (ROM), flash memory, etc.), or some combination of the two. The processing unit(s) may be a standard programmable processor that performs arithmetic and logic operations necessary for the operation of the computing device. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device 200 may also include a bus or other communication mechanism for communicating information among various components of the computing device.

The computing device may have additional features/functionality. For example, computing devices may include additional storage such as removable storage and non-removable storage including, but not limited to, magnetic or optical disks or tapes. The computing device may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The computing device may also have input device(s) 270 such as keyboards, keypads, switches, dials, mice, trackballs, touch screens, voice recognizers, card readers, paper tape readers, or other well-known input devices. Output device(s) 260 such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is are not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture in order to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

It should be appreciated that any of the components or modules referred to with regards to any of the present embodiments discussed herein may be integrally or separately formed with one another. Further, redundant functions or structures of the components or modules may be implemented. Moreover, the various components may be communicated locally and/or remotely with any user/clinician/patient or machine/system/computer/processor.

Moreover, the various components may be in communication via wireless and/or hardwire or other desirable and available communication means, systems, and hardware. Moreover, various components and modules may be substituted with other modules or components that provide similar functions.

Machine Learning. In addition to the machine learning features described above, the analysis system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan h, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications and publications as listed below and throughout this document are hereby incorporated by reference in their entirety herein.
[1] AnnMarie Spexet, Jessica LaRocco-Olszewski, Eric Klein, et al. “Data Management Considerations and Curation for Aviation Maintenance”. In: Proceedings of the 2022 AAAI fall symposium. 2022.
[2] Randy E. Bolling. Method and system for compression for ACARS and related transmissions. US Patent U.S. Pat. No. 9,596,289B2. 2014. URL: https://patents.google.com/patent/U.S. Pat. No. 9,596,289B2.
[3] Eric Foster. Compression and data encoding for transmission over a character-based protocol. US Patent US20070205925A1. 2006. URL: https://patents.google.com/patent/US20070205925.
[4] A. Roy. “Secure aircraft communications addressing and reporting system (ACARS)”. In: 20th DASC. 20th Digital Avionics Systems Conference (Cat. No. 01CH37219). Vol. 2. 2001, 7A2/1-7A2/11 vol. 2. DOI: 10.1109/DASC.2001.964182.
[5] Hemil Patel, Derek Lau, and Deepak Kulkami. “Compressing Aviation Data in XML Format”. In: ( ). URL: https://ntrs.nasa.gov/api/citations/20030067379/downloads/20030067379.pdf.
[6] Sherif Sakr. “XML compression techniques: A survey and comparison”. In: Journal of Computer and System Sciences 75 (August 2009), pp. 303-322. DOI: 10.1016/j.jcss.2009.01.004.
[7] Panagiotis Korvesis, Stephane Besseau, and Michalis Vazirgiannis. “Predictive maintenance in aviation: Failure prediction from post-flight reports”. In: 2018 IEEE 34th International Conference on Data Engineering (ICDE). IEEE. 2018, pp. 1414-1422.
[8] Ziming Zheng, Zhiling Lan, Byung H Park, et al. “System log pre-processing to improve failure prediction”. In: 2009 IEEE/IFIP International Conference on Dependable Systems & Networks. IEEE. 2009, pp. 572-577.
[9] Felix Salfner and Steffen Tschirpke. “Error Log Processing for Accurate Failure Prediction.” In: WASL. 2008.
[10] Michael F Buckley and Daniel P Siewiorek. “A comparative analysis of event tupling schemes”. In: Proceedings of Annual Symposium on Fault Tolerant Computing. IEEE. 1996, pp. 294-303.
[11] Yinglung Liang, Yanyong Zhang, Anand Sivasubramaniam, et al. “Filtering failure logs for a bluegene/l prototype”. In: 2005 International Conference on Dependable Systems and Networks (DSN'05). IEEE. 2005, pp. 476-485.
[12] Marcello Cinque, Raffaele Della Corte, and Antonio Pecchia. “Contextual filtering and prioritization of computer application logs for security situational awareness”. In: Future Generation Computer Systems 111 (2020), pp. 668-680.
[13] Marcello Cinque, Raffaele Della Corte, Giorgio Farina, et al. “An unsupervised approach to discover filtering rules from diagnostic logs”. In: (2022).
[14] Chatschik Bisdikian. “On sensor sampling and quality of information: A starting point”. In: Fifth Annual IEEE International Conference on Pervasive Computing and Communications Workshops (PerComW'07). IEEE. 2007, pp. 279-284.
[15] Jae Kwang Kim and Zhonglei Wang. “Sampling techniques for big data analysis”. In: International Statistical Review 87 (2019), S177-S191.
[16] Joffrey L Leevy, Taghi M Khoshgoftaar, Richard A Bauder, et al. “A survey on addressing high-class imbalance in big data”. In: Journal of Big Data 5.1 (2018), pp. 1-30.
[17] Mohiuddin Ahmed. “Intelligent big data summarization for rare anomaly detection”. In: IEEE Access 7 (2019), pp. 68669-68677.
[18] Ankur Jain and Edward Y Chang. “Adaptive sampling for sensor networks”. In: Proceedings of the 1st international workshop on Data management for sensor networks: in conjunction with VLDB 2004. 2004, pp. 10-16.
[19] Dimitrios Giouroukis, Alexander Dadiani, Jonas Traub, et al. “A survey of adaptive sampling and filtering algorithms for the internet of things”. In: Proceedings of the 14th ACM International Conference on Distributed and Event-based Systems. 2020, pp. 27-38.]
[20] Andr L L De Aquino, Carlos MS Figueiredo, Eduardo F Nakamura, et al. “Data stream based algorithms for wireless sensor network applications”. In: 21st International Conference on Advanced Information Networking and Applications (AlNA'07). IEEE. 2007, pp. 869-876.
[21] Christopher W Karvetski, David R Mandel, and Daniel Irwin. “Improving probability judgment in intelligence analysis: From structured analysis to statistical aggregation”. In: Risk Analysis 40.5 (2020), pp. 1040-1057.
[22] Kiran Maraiya, Kamal Kant, and Nitin Gupta. “Wireless sensor network: a review on data aggregation”. In: International Journal of Scientific & Engineering Research 2.4 (2011), pp. 1-6.
[23] Joaquim AP Braga and António R Andrade. “Multivariate statistical aggregation and dimensionality reduction techniques to improve monitoring and maintenance in railways: The wheelset component”. In: Reliability Engineering & System Safety 216 (2021), p. 107932.
[24] Artur J Ferreira and Mário AT Figueiredo. “Feature discretization with relevance and mutual information criteria”. In: Pattern recognition applications and methods. Springer, 2015, pp. 101-118.
[25] Samira Ghodratnama, Mehrdad Zakershahrak, and Fariborz Sobhanmanesh. “Am i rare? an intelligent summarization approach for identifying hidden anomalies”. In: International Conference on Service Oriented Computing. Springer. 2020, pp. 309-323.
[26] Lishuai Li, Santanu Das, R John Hansman, et al. “Analysis of flight data using clustering techniques for detecting abnormal operations”. In: Journal of Aerospace information systems 12.9 (2015), pp. 587598.
[27] Matthäus Kleindessner, Pranjal Awasthi, and Jamie Morgenstern. “Fair k-center clustering for data summarization”. In: International Conference on Machine Learning. PMLR. 2019, pp. 3448-3457.
[28] Oluseun Omotola Aremu, Adrià Salvador Palau, Ajith Kumar Parlikad, et al. “Structuring data for intelligent predictive maintenance in asset management”. In: IFAC-PapersOnLine 51.11 (2018), pp. 514-519.
[29] Kaijian Liu and Nora El-Gohary. “Feature discretization and selection methods for supporting bridge deterioration prediction”. In: Construction Research Congress 2018. 2018, pp. 413-423.
[30] Ian T Jolliffe and Jorge Cadima. “Principal component analysis: a review and recent developments”. In: Philosophical transactions of the royal society A: Mathematical, Physical and Engineering Sciences 374.2065 (2016), p. 20150202.
[31] Boulanouar Khedidja, Hadjali Allel, and Lagha Mohand. “Data summarization for sensor data management: towards computational-intelligence-based approaches”. In: International Journal of Computing and Digital Systems 9.5 (2020), pp. 825-833.
[32] Liyan Tang, Zhaoyi Sun, Betina Idnay, et al. “Evaluating large language models on medical evidence summarization”. In: npj Digital Medicine 6.1 (August 2023). DOI: 10. 1038/s41746-023-00896-7. URL: https://doi.org/10.1038/s41746-023-00896-7.
[33] Merlinda Wibowo, Fiftin Noviyanto, Sarina Sulaiman, et al. “Machine Learning Technique For Enhancing Classification Performance In Data Summarization Using Rough Set And Genetic Algorithm”. In: Int. J. Sci. Technol. Res 8.10 (2019), pp. 1108-1119.
[34] AnnMarie Spexet, Jessica LaRocco-Olszewski, and David Alvord. “Data Pipeline Considerations for Aviation Maintenance”. In: 2023 IEEE Aerospace Conference. 2023, pp. 1-7. DOI: 10.1109/AERO55745.2023. 10115656.
[35] FlightAware. FlightAware and ADS-B. https://www.flightaware.com/adsb/, Last accessed on 2023 Oct. 3. 2023.
[35] Tejas G Puranik, Nicolas Rodriguez, and Dimitri N Mavris. “Towards online prediction of safety-critical landing metrics in aviation using supervised machine learning”. In: Transportation Research Part C: Emerging Technologies 120 (2020), p. 102819.
[36] Junzi Sun, Joost Ellerbroek, and Jacco Hoekstra. “Large-scale flight phase identification from ads-b data using machine learning methods”. In: 7th International Conference on Research in Air Transportation. 2016, pp. 1-8.
[37] Qilei Zhang, John H Mott, Mary E Johnson, et al. “Development of a reliable method for general aviation flight phase identification”. In: IEEE Transactions on Intelligent Transportation Systems (2021).
[38] Xavier Olive, Junzi Sun, Adrien Lafage, et al. “Detecting Events in Aircraft Trajectories: Rule-Based and Data-Driven Approaches”. In: Multidisciplinary Digital Publishing Institute Proceedings 59.1 (2020), p. 8.
[40] Qilei Zhang and John H Mott. “Improved Framework for Classification of Flight Phases of General Aviation Aircraft”. In: Transportation Research Record (2022), p. 03611981221127016.
[41] Junzi Sun, Joost Ellerbroek, and Jacco Hoekstra. “Flight extraction and phase identification for large automatic dependent surveillance-broadcast datasets”. In: Journal of Aerospace Information Systems 14.10 (2017), pp. 566-572.
[42] Mohiuddin Ahmed. “Data summarization: a survey”. In: Knowledge and Information Systems 58.2 (2019), pp. 249-273.
[43] Samira Ghodratnama, Amin Beheshti, Mehrdad Zakershahrak, et al. “Intelligent Narrative Summaries: From Indicative to Informative Summarization”. In: Big Data Research 26 (2021), p. 100257. ISSN: 22145796. DOI: https://doi.org/10.1016/j.bdr.2021.100257. URL: https://www.sciencedirect.com/science/article/pii/S2214579621000745.
[44] Liana Ermakova, Jean Valere Cossu, and Josiane Mothe. “A survey on evaluation of summarization methods”. In: Information processing & management 56.5 (2019), pp. 1794-1814.
[45] Kazi Arif-Uz-Zaman, Michael E Cholette, Lin Ma, et al. “Extracting failure time data from industrial maintenance records using text mining”. In: Advanced Engineering Informatics 33 (2017), pp. 388-396.
[46] Brett Edwards, Michael Zatorsky, and Richi Nayak. “Clustering and classification of maintenance logs using text data mining”. In: Volume 87-Data Mining and Analytics 2008 (2008), pp. 193-199.
[47] Zhe Yang, Piero Baraldi, and Enrico Zio. “A novel method for maintenance record clustering and its application to a case study of maintenance optimization”. In: Reliability Engineering & System Safety 203 (2020), p. 107103.
[48] James C. Chen, Tzu-Li Chen, Wei-Jun Liu, et al. “Combining empirical mode decomposition and deep recurrent neural networks for predictive maintenance of lithium-ion battery”. In: Advanced Engineering Informatics 50 (2021), p. 101405. ISSN: 1474-0346. DOI: https://doi.org/10.1016/j.aei.2021.101405. URL: https://www. sciencedirect.com/science/article/pii/S1474034621001579.
[49] Chuang Chen, Guanye Tao, Jiantao Shi, et al. “A Lithium-Ion Battery Degradation Prediction Model with Uncertainty Quantification for Its Predictive Maintenance”. In: IEEE Transactions on Industrial Electronics (2023), pp. 1-10. DOI: 10.1109/TIE.2023. 3274874.
[30] Shahid A. Hasib, S. Islam, Ripon K. Chakrabortty, et al. “A Comprehensive Review of Available Battery Datasets, RUL Prediction Approaches, and Advanced Battery Management”. In: IEEE Access 9 (2021), pp. 86166-86193. DOI: 10. 1109/ACCESS. 2021. 3089032.

### Reference List #2

[1A] Lampe, M., Strassner, M., and Fleisch, E., “A Ubiquitous Computing Environment for Aircraft Maintenance,” University of St.Gallen, 2004. https://doi.org/10.1145/967900.968217
[2A] Spexet, A., LaRocco-Olszewski, J., Klein, E., Breen, N., and Alvord, D., “Data Management Considerations and Curation for Aviation Maintenance,” Proceedings of the 2022 AAAI fall symposium, 2022.
[3A] Spexet, A., LaRocco-Olszewski, J., and Alvord, D., “Data Pipeline Considerations for Aviation Maintenance,” 2023 Aerospace Conference, 2023, pp. 1-7. IEEE https://doi.org/10.1109/AER 0115656
[4A] Bolling, R. E., “Method and system for compression for ACARS and related transmissions,”, 2014. URL https://patents.google.com/patent/U.S. Pat. No. 9,596,289B2, uS Patent U.S. Pat. No. 9,596,289B2.
[5A] Foster, E., “Compression and data encoding for transmission over a character-based protocol,”, 2006. URL https://patents.google.com/208925, uS Patent US20070205925A1.
[6A] Roy, A., “Secure aircraft communications addressing and reporting system (ACARS),” 20th DASC. 20th Digital Avionics Systems Conference (Cat. No. 01CH37219), Vol. 2, 2001, pp. 7A2/1-7A2/11 vol. 2. https://doi.org/10.1109/DASC.2001.964182
[7A] Korvesis, P., Besseau, S., and Vazirgiannis, M., “Predictive maintenance in aviation: Failure prediction from post-flight reports,” 2018 IEEE 34th International Conference on Data Engineering (ICDE), IEEE, 2018, pp. 1414-1422.
[8A] Zheng, Z., Lan, Z., Park, B. H., and Geist, A., “System log pre-processing to improve failure prediction,” 2009 IEEE/IFIP International Conference on Dependable Systems & Networks, IEEE, 2009, pp. 572-577.
[9A] Salfner, F., and Tschirpke, S., “Error Log Processing for Accurate Failure Prediction.” WASL, 2008.
[10A] Buckley, M. F., and Siewiorek, D. P., “A comparative analysis of event tupling schemes,” Proceedings of Annual Symposium on Fault Tolerant Computing, IEEE, 1996, pp. 294-303.
[11A] Liang, Y., Zhang, Y., Sivasubramaniam, A., Sahoo, R. K., Moreira, J., and Gupta, M., “Filtering failure logs for a bluegene/l prototype,” 2005 International Conference on Dependable Systems and Networks (DSN′05), IEEE, 2005, pp. 476-485.
[12A] Cinque, M., Della Corte, R., and Pecchia, A., “Contextual filtering and prioritization of computer application logs for security situational awareness,” Future Generation Computer Systems, Vol. 111, 2020, pp. 668-680.
[13A] Cinque, M., Della Corte, R., Farina, G., and Rosiello, S., “An unsupervised approach to discover filtering rules from diagnostic logs,” 2022.
[14A] Bisdikian, C., “On sensor sampling and quality of information: A starting point,” Fifth Annual IEEE International Conference on Pervasive Computing and Communications Workshops (PerComW'07), IEEE, 2007, pp. 279-284.
[15A] Kim, J. K., and Wang, Z., “Sampling techniques for big data analysis,” International Statistical Review, Vol. 87, 2019, pp. S177-S191.
[16A] Leevy, J. L., Khoshgoftaar, T. M., Bauder, R. A., and Seliya, N., “A survey on addressing high-class imbalance in big data,” Journal of Big Data, Vol. 5, No. 1, 2018, pp. 1-30.
[17A] Ahmed, M., “Intelligent big data summarization for rare anomaly detection,” IEEE Access, Vol. 7, 2019, pp. 68669-68677.
[18A] Jain, A., and Chang, E. Y., “Adaptive sampling for sensor networks,” Proceedings of the 1 st international workshop on Data management for sensor networks: in conjunction with VLDB 2004, 2004, pp. 10-16.
[19A] Giouroukis, D., Dadiani, A., Traub, J., Zeuch, S., and Markl, V., “A survey of adaptive sampling and filtering algorithms for the internet of things,” Proceedings of the 14th ACM International Conference on Distributed and Event-based Systems, 2020, pp. 27-38.
[20A] De Aquino, A. L., Figueiredo, C. M., Nakamura, E. F., Buriol, L. S., Loureiro, A. A., Fernandes, A. O., and Claudionor Jr, J., “Data stream based algorithms for wireless sensor network applications,” 21st International Conference on Advanced Information Networking and Applications (AlNA'07), IEEE, 2007, pp. 869-876.
[21A] Karvetski, C. W., Mandel, D. R., and Irwin, D., “Improving probability judgment in intelligence analysis: From structured analysis to statistical aggregation,” Risk Analysis, Vol. 40, No. 5, 2020, pp. 1040-1057.
[22A] Maraiya, K., Kant, K., and Gupta, N., “Wireless sensor network: a review on data aggregation,” International Journal of Scientific & Engineering Research, Vol. 2, No. 4, 2011, pp. 1-6.
[23A] Braga, J. A., and Andrade, A. R., “Multivariate statistical aggregation and dimensionality reduction techniques to improve monitoring and maintenance in railways: The wheelset component,” Reliability Engineering & System Safety, Vol. 216, 2021, p. 107932.
[24A] Ferreira, A. J., and Figueiredo, M. A., “Feature discretization with relevance and mutual information criteria,” Pattern recognition applications and methods, Springer, 2015, pp. 101-118.
[25A] Ghodratnama, S., Zakershahrak, M., and Sobhanmanesh, F., “Am i rare? an intelligent summarization approach for identifying hidden anomalies,” International Conference on Service-Oriented Computing, Springer, 2020, pp. 309-323.
[26A] Li, L., Das, S., John Hansman, R., Palacios, R., and Srivastava, A. N., “Analysis of flight data using clustering techniques for detecting abnormal operations,” Journal of Aerospace information systems, Vol. 12, No. 9, 2015, pp. 587-598.
[27A] Kleindessner, M., Awasthi, P., and Morgenstern, J., “Fair k-center clustering for data summarization,” International Conference on Machine Learning, PMLR, 2019, pp. 3448-3457.
[28A] Aremu, O. O., Palau, A. S., Parlikad, A. K., Hyland-Wood, D., and McAree, P. R., “Structuring data for intelligent predictive maintenance in asset management,” IFAC-PapersOnLine, Vol. 51, No. 11, 2018, pp. 514-519.
[29A] Liu, K., and El-Gohary, N., “Feature discretization and selection methods for supporting bridge deterioration prediction,” Construction Research Congress 2018, 2018, pp. 413-423.
[30A] Liu, Y., Fabbri, A. R., Liu, P., Radev, D., and Cohan, A., “On Learning to Summarize with Large Language Models as References,”, 2023.
[31A] Sowdaboina, P. K. V., Chakraborti, S., and Sripada, S., “Learning to Summarize Time Series Data,” Computational Linguistics and Intelligent Text Processing, edited by A. Gelbukh, Springer Berlin Heidelberg, Berlin, Heidelberg, 2014, pp. 515-528.
[32A] Jiang, Y., Pan, Z., Zhang, X., Garg, S., Schneider, A., Nevmyvaka, Y., and Song, D., “Empowering Time Series Analysis with Large Language Models: A Survey,”, 2024.
[33A] Patel, H., Lau, D., and Kulkami, D., “Compressing Aviation Data in XML Format,” https://ntrs.nasa.gov/api/citations/20030067379/downloads/20030067379.pdf
[34A] Sakr, S., “XML compression techniques: A survey and comparison,” Journal of Computer and System Sciences, Vol. 75, 2009, pp. 303-322. https://doi.org/10.1016/j.jcss.2009.01.004
[35A] Jolliffe, I. T., and Cadima, J., “Principal component analysis: a review and recent developments,” Philosophical transactions of the royal society A: Mathematical, Physical and Engineering Sciences, Vol. 374, No. 2065, 2016, p. 20150202.
[36A] Khedidja, B., Allel, H., and Mohand, L., “Data summarization for sensor data management: towards computational-intelligence based approaches,” International Journal of Computing and Digital Systems, Vol. 9, No. 5, 2020, pp. 825-833.
[37A] Tang, L., Sun, Z., Idnay, B., Nestor, J. G., Soroush, A., Elias, P. A., Xu, Z., Ding, Y., Durrett, G., Rousseau, J. F., Weng, C., and Peng, Y., “Evaluating large language models on medical evidence summarization,” npj Digital Medicine, 6, Vol. No. 1, 2023. https://doi.org/10.1038/s41746-023-00896-7. URL https://doi.org/10.1038/s41746-023-00896-7
[38A] Lewis, P., Perez, E., Piktus, A., Petroni, F., Karpukhin, V., Goyal, N., Küttler, H., Lewis, M., Yih, W.-t., Rocktäschel, T., et al., “Retrieval-augmented generation for knowledge-intensive nlp tasks,” Advances in Neural Information Processing Systems, Vol. 33, 2020, pp. 9459-9474.
[39A] Wibowo, M., Noviyanto, F., Sulaiman, S., and Shamsuddin, S. M., “Machine Learning Technique For Enhancing Classification Performance In Data Summarization Using Rough Set And Genetic Algorithm,” Int. J. Sci. Technol. Res, Vol. 8, No. 10, 2019, pp. 1108-1119.
[40A] Mansfield, N. J., and Aggarwal, G., “Whole-Body Vibration Experienced by Pilots, Passengers and Crew in Fixed-Wing Aircraft: A State-of-the-Science Review,” Vibration, Vol. 5, No. 1, 2022, pp. 110-120. https://doi.org/10.3390/vibration5010007. URL https://www.mdpi.com/2571-631X/5/1/7
[41A] Thomas, B., “SensorLog,”, 2024. URL http://sensorlog.berndthomas.net/[42A] Sharman, R., Cornman, L., Williams, J., Koch, S., and Moninger, W., “3.3 THE FAA A WRP TURBULENCE PDT,” 2016.
[43A] Sigalotti, L. D. G., Peregrino, F. C., and Ramírez-Rojas, A., Air Turbulence and its Methods of Detection, CRC Press, Boca Raton, 2023.
[44A] Kopeć, J. M., Kwiatkowski, K., de Haan, S., and Malinowski, S. P., “Retrieving atmospheric turbulence information from regular commercial aircraft using Mode-S and ADS-B,” Atmospheric Measurement Techniques, Vol. 9, No. 5, 2016, pp. 2253-2265. https://doi.org/10.5194/amt-9-2253-2016. URL https://amt.copernicus.org/articles/9/2253/2016/[45A] FlightAware, “FlightAware and ADS-B,”, 2023. https://www.flightaware.com/adsb//Last accessed on 2023 Oct. 3.
[46A] Putra, I. P. E. S., Brusey, J., Gaura, E., and Vesilo, R., “An event-triggered machine learning approach for accelerometer-based fall detection,” Sensors, Vol. 18, No. 1, 2017, p. 20.
[47A] Pearson, K., “On lines and planes of closest fit to systems of points in space,” The London, Edinburgh, and Dublin philosophical magazine and journal of science, Vol. 2, No. 11, 1901, pp. 559-572.
[48A] De Maesschalck, R., Jouan-Rimbaud, D., and Massart, D. L., “The mahalanobis distance,” Chemometrics and intelligent laboratory systems, Vol. 50, No. 1, 2000, pp. 1-18.
[49A] He, D., Wu, S., and Bechhoefer, E., A Regime Recognition Algorithm for Helicopter Usage Monitoring, 2010. https://doi.org/10.5772/7165
[50A] Wu, J., Hu, C., Sun, C., Chen, X., and Yan, R., “Aircraft flight regime recognition with deep temporal segmentation neural network,” Engineering Applications of Artificial Intelligence, Vol. 120, 2023, p. 105840. https://doi.org/https://doi.org/10.1016/j.engappai.2023.105840. URL https://www.sciencedirect.com/science/article/pii/S0952197623000246
[51A] Leoni, J., Zinnari, F., Villa, E., Tanelli, M., and Baldi, A., “Flight regimes recognition in actual operating conditions: A functional data analysis approach,” Engineering Applications of Artificial Intelligence, 114, Vol. 2022, p. 105016. https://doi.org/https:///doi.org/10.1016/j.engappai.2022.105016. URL https://www.sciencedirect.com/science/article/pii/S095219762200197X
[52A] Puranik, T. G., Rodriguez, N., and Mavris, D. N., “Towards online prediction of safety-critical landing metrics in aviation using supervised machine learning,” Transportation Research Part C: Emerging Technologies, Vol. 120, 2020, p. 102819.
[53A] Sun, J., Ellerbroek, J., and Hoekstra, J., “Large-scale flight phase identification from ads-b data using machine learning methods,” 7th International Conference on Research in Air Transportation, 2016, pp. 1-8.
[54A] Zhang, Q., Mott, J. H., Johnson, M. E., and Springer, J. A., “Development of a reliable method for general aviation flight phase identification,” IEEE Transactions on Intelligent Transportation Systems, 2021.
[55A] Olive, X., Sun, J., Lafage, A., and Basora, L., “Detecting Events in Aircraft Trajectories: Rule-Based and Data-Driven Approaches,” Multidisciplinary Digital Publishing Institute Proceedings, Vol. 59, No. 1, 2020, p. 8.
[56A] Zhang, Q., and Mott, J. H., “Improved Framework for Classification of Flight Phases of General Aviation Aircraft,” Transportation Research Record, 2022, p. 03611981221127016.
[57A] Sun, J., Ellerbroek, J., and Hoekstra, J., “Flight extraction and phase identification for large automatic dependent surveillancebroadcast datasets,” Journal of Aerospace Information Systems, Vol. 14, No. 10, 2017, pp. 566-572.
[58A] Ahmed, M., “Data summarization: a survey,” Knowledge and Information Systems, Vol. 58, No. 2, 2019, pp. 249-273.
[59A] Ghodratnama, S., Beheshti, A., Zakershahrak, M., and Sobhanmanesh, F., “Intelligent Narrative Summaries: From Indicative to Informative Summarization,” Big Data Research, Vol. 26, 2021, p. 100257. https://doi.org/https://doi.org/10.1016/j.bdr.2021. 100257. URL https://www.sciencedirect.com/science/article/pii/S2214579621000745
[60A] Ermakova, L., Cossu, J. V., and Mothe, J., “A survey on evaluation of summarization methods,” Information processing & management, Vol. 56, No. 5, 2019, pp. 1794-1814.

What is claimed:

1. A method of performing flight monitoring, the method comprising:
receiving, by a processor of a mobile device, external flight data acquired from one or more sensors of the mobile device external to an aircraft flight controller for an aircraft during flight, wherein the external flight data comprises at least one of acceleration data, gyroscope data, or IMU data;
windowing, by the processor, the external flight data, cluster the at least one of acceleration data, gyroscope data, or inertia measurement unit (IMU) data of the flight data to define a plurality of time windows;
extracting, by the processor, a plurality of features from the windowed flight data;
determining, by the processor, based on the plurality of features, a set of flight regimes including at least one of level flight, landing, turning, and taking off, for each of the plurality of time windows; and
outputting, by the processor, at a graphical user interface of the mobile device or a remote device, the determined set of flight regimes to be used to monitor flight events.

2. The method of claim 1 further comprising:
receiving, by the processor, accelerometer data captured during a flight and at around 100 Hz and excluding engine frequency;
determining, by the processor, period of turbulent event from the accelerometer data;
outputting, by the processor, the determined period of turbulent event during the flight.

3. The method of claim 1 further comprising:
determining, via an outlier detection operator, based on the plurality of features, presence of a flight anomaly; and
outputting, by the processor, the determined presence of a flight anomaly, wherein the outputted determination for flight anomaly is used for predictive maintenance of the aircraft.

4. The method of claim 1, further comprising:
determining, by the processor, based on the plurality of features, a flight path for the aircraft for the flight; and
outputting, by the processor, at the graphical user interface of the mobile device or the remote device, the determined flight path.

5. The method of claim 1, wherein the plurality of features includes at least one of:
minimum value of each axis of the acceleration data;
minimum value of each axis of the gyroscope data;
maximum value of each axis of the acceleration data;
maximum value of each axis of the gyroscope data;
mean value of each axis of the acceleration data;
mean value of each axis of the gyroscope data;
variance value for magnitude of the acceleration data for one axis;
variance value for magnitude of the gyroscope data for one axis; and
a value for a signal magnitude area determined for one axis of the acceleration data.

6. The method of claim 5, comprising:
determining presence of a flight anomaly using a thresholded value from a Mahalanobis distances determined for at least one of the plurality of features;
outputting, by the processor, the determined presence of a flight anomaly, wherein the outputted determination for flight anomaly is used for predictive maintenance of the aircraft.

7. The method of claim 1, wherein the aircraft is a fixed-wing aircraft.

8. The method of claim 1, wherein the aircraft is a helicopter.

9. A non-transitory computer readable medium having instructions stored thereon, wherein execution of the instructions by a processor causes the processor to:
receive external flight data acquired from one or more sensors of the mobile device external to an aircraft flight controller for an aircraft during flight, wherein the external flight data comprises at least one of acceleration data, gyroscope data, or IMU data;
window the external flight data, cluster the at least one of acceleration data, gyroscope data, or inertia measurement unit (IMU) data of the flight data to define a plurality of time windows;
extract a plurality of features from the windowed flight data;
determining, by the processor, based on the plurality of features, a set of flight regimes including at least one of level flight, landing, turning, and taking off, for each of the plurality of time windows; and
output, at a graphical user interface of the mobile device or a remote device, the determined set of flight regimes to be used to monitor flight events.

10. The computer readable medium of claim 9, wherein execution of the instructions by the processor further causes the processor to:
receive accelerometer data captured during a flight and at around 100 Hz and excluding engine frequency;
determine period of turbulent event from the accelerometer data;
output the determined period of turbulent event during the flight.

11. The computer readable medium of claim 9, wherein execution of the instructions by the processor further causes the processor to:
determine, via an outlier detection operator, based on the plurality of features, presence of a flight anomaly; and
output, by the processor, the determined presence of a flight anomaly, wherein the outputted determination for flight anomaly is used for predictive maintenance of the aircraft.

12. The computer readable medium of claim 9, wherein execution of the instructions by the processor further causes the processor to:
determine based on the plurality of features, a flight path for the aircraft for the flight; and
output, at the graphical user interface of the mobile device or the remote device, the determined flight path.

13. The computer readable medium of claim 9, wherein the plurality of features includes at least one of:
minimum value of each axis of the acceleration data;
minimum value of each axis of the gyroscope data;
maximum value of each axis of the acceleration data;
maximum value of each axis of the gyroscope data;
mean value of each axis of the acceleration data;
mean value of each axis of the gyroscope data;
variance value for magnitude of the acceleration data for one axis;
variance value for magnitude of the gyroscope data for one axis; and
a value for a signal magnitude area determined for one axis of the acceleration data.

14. The computer readable medium of claim 13, wherein execution of the instructions by the processor further causes the processor to:
determine presence of a flight anomaly using a thresholded value from a Mahalanobis distances determined for at least one of the plurality of features;
outputting, by the processor, the determined presence of a flight anomaly, wherein the outputted determination for flight anomaly is used for predictive maintenance of the aircraft.

15. A method of performing flight monitoring, the method comprising:
receiving, by a processor of a computing device, external flight data acquired from one or more sensors of a remote instrument external to an aircraft flight controller for an aircraft during flight, wherein the external flight data comprises at least one of acceleration data, gyroscope data, or IMU data;
windowing, by the processor, the external flight data cluster the at least one of acceleration data, gyroscope data, or inertia measurement unit (IMU) data of the flight data to define a plurality of time windows;
extracting, by the processor, a plurality of features from the windowed flight data;
determining, by the processor, based on the plurality of features, a set of flight regimes including at least one of level flight, landing, turning, and taking off, for each of the plurality of time windows; and
outputting, by the processor, at a graphical user interface of the computing device or a remote device, the determined set of flight regimes to be used to monitor flight events.

16. The method of claim 15 further comprising:
receiving, by the processor, accelerometer data captured during a flight and at around 100 Hz and excluding engine frequency;
determining, by the processor, period of turbulent event from the accelerometer data;
outputting, by the processor, the determined period of turbulent event during the flight.

17. The method of claim 15 further comprising:
determining, via an outlier detection operator, based on the plurality of features, presence of a flight anomaly; and
outputting, by the processor, the determined presence of a flight anomaly, wherein the outputted determination for flight anomaly is used for predictive maintenance of the aircraft.

18. The method of claim 15, further comprising:
determining, by the processor, based on the plurality of features, a flight path for the aircraft for the flight; and
outputting, by the processor, at the graphical user interface of the mobile device or the remote device, the determined flight path.

19. The method of claim 15, wherein the plurality of features includes at least one of:
minimum value of each axis of the acceleration data;
minimum value of each axis of the gyroscope data;
maximum value of each axis of the acceleration data;
maximum value of each axis of the gyroscope data;
mean value of each axis of the acceleration data;
mean value of each axis of the gyroscope data;
variance value for magnitude of the acceleration data for one axis;
variance value for magnitude of the gyroscope data for one axis; and
a value for a signal magnitude area determined for one axis of the acceleration data.

20. The method of claim 19, comprising:
determining presence of a flight anomaly using a thresholded value from a Mahalanobis distances determined for at least one of the plurality of features;
outputting, by the processor, the determined presence of a flight anomaly, wherein the outputted determination for flight anomaly is used for predictive maintenance of the aircraft.
